(19) United States
(12) Patent Application Publication
(10) Pub. No.: US 2026/0295398 A1
(43) Pub. Date: Oct. 1, 2026

(54) GAME SYSTEM, NON-TRANSITORY COMPUTER-READABLE STORAGE MEDIA, AND COMPUTER-IMPLEMENTED METHOD

(71) Applicant: NINTENDO CO., LTD., Kyoto-shi (JP)

(72) Inventors: Minori KOIKE, Kyoto-shi (JP); Satoshi KAWAMATA, Kyoto-shi (JP); Masahiro SHOJI, Kyoto-shi (JP); Kento HOSHI, Kyoto-shi (JP); Masayoshi MATSUOKA, Kyoto-shi (JP)

(21) Appl. No.: 19/571,943

(22) Filed: Mar. 19, 2026

(30) Foreign Application Priority Data
Mar. 28, 2025 (JP) 2025-056742

(51) Int. Cl. A63F 13/355; A63F 13/52

(52) U.S. Cl. CPC A63F 13/355; A63F 13/52

(57) ABSTRACT

A game system comprising a first game device and a second game device. The first game device receives operation data of the second game device, executes a game program using its own operation data and the received operation data to generate a game image, encodes the generated game image in a method in which a bit rate changes, and transmits the encoded game image to the second game device. The game system determines display quality of the game image at the second game device based on at least one of a communication status in communication of the game image and an encoding bit rate. An icon indicating the display quality is displayed on a display of the second game device with the game image.

This nonprovisional application claims priority on Japanese Patent Application No. 2025-056742 filed with the Japan Patent Office on March 28, 2025, the entire contents of which are hereby incorporated by reference.

### FIELD

The present disclosure relates to, for example, a game system, an information processing system, a program, and a control method for a game system that execute a program for a multiplayer game, etc.

### BACKGROUND AND SUMMARY

Conventionally, there is a technology for transmitting an image from one game device to another game device and displaying the image on the other game device.

There is room for improvement in a method for determining display quality of a transmitted image or a method for displaying the transmitted image.

(Configuration 1) A game system according to an embodiment comprises a first game device and a second game device. The first game device is configured to perform operations comprising: receiving operation data of the second game device; executing a game program using its own operation data and the received operation data to generate a game image; encoding the generated game image in a method in which a bit rate changes; and transmitting the encoded game image to the second game device. The game system is configured to perform operations comprising determining display quality of the game image displayed at the second game device based on at least one of a communication status in communication of the game image and the encoding bit rate; and displaying, with the game image, an icon indicating the display quality on a display of the second game device.

(Configuration 2) In Configuration 1, the determination is performed based on at least the communication status in communication of the game image and the encoding bit rate, and the icon is a single icon that changes based on at least the communication status in communication of the game image and the encoding bit rate.

(Configuration 3) In Configuration 2, the encoding is performed in a method in which a set bit rate changes according to the communication status, and the determination is performed based on at least the communication status and the set bit rate.

(Configuration 4) In Configuration 2, the encoding is performed in a method in which a resulting bit rate changes according to an information amount of the game image, and the determination is performed based on at least the communication status and the resulting bit rate.

(Configuration 5) In Configuration 2, the operations further comprise determining the communication status according to at least communication delay and data loss on a communication path of the game image.

(Configuration 6) In Configuration 1, the operations further comprise receiving a selection input between local wireless communication and Internet communication as a communication method for transmitting the game image. The determination, when the local wireless communication is selected in the selection input, is performed based on at least data loss on a communication path of the game image, and when the Internet communication is selected, is performed based on at least communication delay of the game image.

(Configuration 7) In Configuration 6, the encoding is performed in a method in which a set bit rate changes according to the communication status. The determination is performed based on at least the set bit rate and data loss on a communication path of the game image when the local wireless communication is selected in the selection input, and is performed based on the set bit rate and communication delay of the game image when the Internet communication is selected in the selection input.

(Configuration 8) In Configuration 1, the game system comprises a plurality of second game devices, the determination is performed based on at least the communication status and the encoding bit rate for each second game device, and the icon is displayed for each second game device.

(Configuration 9) In Configuration 8, the encoding is performed in a method in which a set bit rate changes according to the communication status, a maximum value of the set bit rate is determined according to the number of the plurality of second game devices, and the determination is performed by comparing a current set bit rate with the maximum value of the set bit rate for each second game device.

(Configuration 10) One or more non-transitory computer-readable storage media according to an embodiment store instructions that cause one or more processors or processing circuits of a second game device of a game system comprising a first game device and the second game device to perform operations comprising: receiving an encoded game image generated and encoded by the first game device and encoding quality data of the game image, from the first game device; determining display quality of the game image displayed at the second game device based on at least a communication status in communication of the game image and the received encoding quality data; and displaying, with the game image, an icon indicating the display quality on a display of the second game device.

(Configuration 11) In Configuration 10, the encoding is performed in a method in which a set bit rate changes according to the communication status, and the encoding quality data includes data indicating the set bit rate.

(Configuration 12) In Configuration 11, the encoding is further performed in a method in which a resulting bit rate changes according to an information amount of the game image, and the encoding quality data includes data indicating the resulting bit rate.

(Configuration 13) In Configuration 12, in the encoding, the value of the set bit rate is changed based on a comparison between the set bit rate and the resulting bit rate, and the determination is performed based on the comparison result.

(Configuration 14) In Configuration 10, the operations further comprise determining the communication status by determining both communication delay and data loss on a communication path of the game image.

(Configuration 15) In Configuration 10, the determination, when local wireless communication is selected for transmitting a game image, is performed based on at least data loss on a communication path of the game image, and when the Internet communication is selected, is performed based on at least communication delay of the game image.

(Configuration 16) In Configuration 15, the encoding is performed in a method in which a set bit rate changes according to the communication status. The determination is performed based on the set bit rate and data loss on a communication path of the game image when the local wireless communication is selected in the selection input, and is performed based on the set bit rate and communication delay of the game image when the selection input of the Internet communication is received.

(Configuration 17) In Configuration 10, the encoding is performed in a method in which a set bit rate changes according to the communication status, a maximum value of the set bit rate is determined according to the number of the second game devices, and the determination is performed by comparing a current set bit rate with the maximum value of the set bit rate.

(Configuration 18) A computer-implemented method for controlling a game system comprising a first game device and a second game device according to an embodiment comprises: the first game device performing operations including receiving operation data of the second game device; executing a game program using its own operation data and the received operation data; generating a game image; encoding the generated game image in a method in which a bit rate changes; and transmitting the encoded game image to the second game device. The game system performs operations including determining display quality of the game image displayed at the second game device based on at least a communication status in communication of the game image and an encoding bit rate; and displaying, with the game image, an icon indicating the display quality on a display of the second game device.

(Configuration 19) In Configuration 18, the encoding is performed in a method in which a set bit rate changes according to the communication status, and the determining is performed based on at least the communication status and the set bit rate.

(Configuration 20) In Configuration 19, the encoding is performed in a method in which a resulting bit rate changes according to an information amount of the game image, and the determining is performed based on at least the communication status and the resulting bit rate.

(Configuration 21) In Configuration 20, in the encoding, the value of the set bit rate is changed based on a comparison between the set bit rate and the resulting bit rate, and the determining is performed based on at least the comparison result.

(Configuration 22) In Configuration 18, the determining is performed based on the encoding bit rate for each second game device.

### BRIEF DESCRIPTION OF THE DRAWINGS

FIG. 1 is a schematic diagram showing an example configuration of an overall system 1 comprising an information processing system according to an embodiment.

FIG. 2 is a schematic diagram showing another example configuration of an overall system 2 comprising an information processing system according to an embodiment.

FIGS. 3A and 3B are schematic diagrams of a flow of game processing in the information processing system according to an embodiment.

FIG. 4 is a schematic diagram showing an example hardware configuration of a game device 100 according to an embodiment.

FIG. 5 is a diagram for explaining an example of a program stored in a flash memory 106 of the game device (host) 100-1 according to an embodiment.

FIGS. 6A and 6B are diagrams for explaining data stored in a DRAM 108 of the game device according to an embodiment.

FIG. 7 is a flow diagram for explaining game processing of the game device (host) according to an embodiment.

FIGS. 8A and 8B are diagrams for explaining a menu screen according to an embodiment.

FIG. 9 is a subroutine flow diagram of member recruitment processing according to an embodiment.

FIG. 10 is a diagram for explaining an example of a connection confirmation screen according to an embodiment.

FIG. 11 is a flow diagram for explaining mode saving processing in a game sharing function according to an embodiment.

FIG. 12 is a flow diagram for explaining streaming start processing according to an embodiment.

FIG. 13 is a subroutine flow diagram of streaming processing according to an embodiment.

FIG. 14 is another subroutine flow diagram of target bit rate setting processing according to an embodiment.

FIG. 15 is another subroutine flow diagram of target bit rate setting processing according to an embodiment.

FIGS. 16A and 16B are diagrams for explaining a change in VBV buffer size according to an embodiment.

FIG. 17 is a subroutine flow diagram of processing for transmitting antenna level related information to a guest G(i) according to an embodiment.

FIG. 18 is another subroutine flow diagram of processing for transmitting antenna level related information to a guest G(i) according to an embodiment.

FIG. 19 is a flow diagram for explaining game processing of the game device (guest) according to an embodiment.

FIG. 20 is a subroutine flow diagram of connection request processing of the game device (guest) according to an embodiment.

FIG. 21 is a diagram for explaining an example of a connection request confirmation screen according to an embodiment.

FIG. 22 is a subroutine flow diagram of antenna level calculation/display processing according to an embodiment.

FIG. 23 is another subroutine flow diagram of antenna level calculation/display processing according to an embodiment.

FIG. 24 is a diagram for explaining a screen of a display 104 of the game device according to an embodiment.

The same reference numerals are assigned to the same or corresponding parts in the drawings, and the description thereof is not repeated.

### DETAILED DESCRIPTION OF NON-LIMITING EXAMPLE EMBODIMENTS

Embodiments are described in detail with reference to the drawings. The same or corresponding parts in the drawings are denoted by the same reference signs, and a description thereof is not repeated.

### A. System Configuration Example

First, an example configuration of a game system, which is an example of an information processing system according to the present embodiment, is described. The game system is an example of an information processing system, and the information processing system may be a system in which a game is not executed. For example, when saying "processor of the information processing system," the processor may mean one or a plurality of processors in a single device, such as a main unit, or may mean a part or all of one or a plurality of processors comprised in each of a plurality of devices.

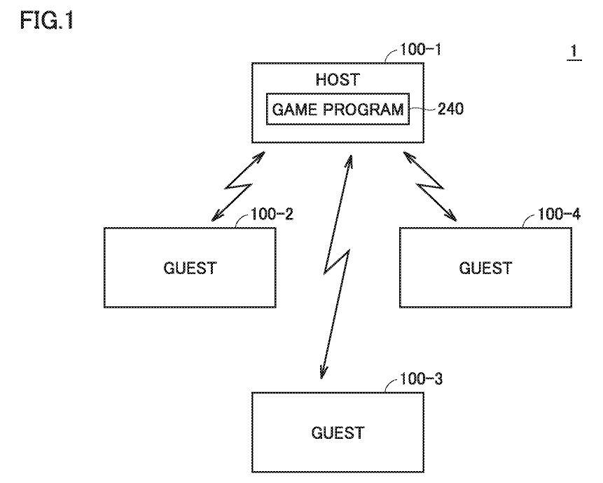

FIG. 1 is a schematic diagram showing an example configuration of an overall system 1 comprising an information processing system according to the present embodiment. A game device 100 is described as an example of the information processing system. However, the information processing system may be, for example, a personal computer, a smartphone, a tablet, a wearable terminal, a smart television, a server, etc.

The term "information processing system" encompasses at least both a configuration in which necessary components are mounted in a single casing and a configuration in which necessary components are separately mounted in a plurality of casings.

Referring to FIG. 1, the overall system 1 comprises one or a plurality of game devices 100. FIG. 1 shows an overall system 1 comprising four game devices 100 as an example. In the following description, when it is necessary to specify each of the plurality of game devices 100, they are distinguished by adding a branch number (for example, game devices 100-1, 100-2, 100-3, and 100-4 shown in FIG. 1). The case where a game device (host) 100-1 is connected to other game devices (guests) 100-2, 100-3, and 100-4 by local wireless communication as an example of a network is shown. As specific examples of local wireless communication, communication using the IEEE 802.11 standard, communication improved from the IEEE 802.11 standard, Bluetooth (registered trademark), ZigBee (registered trademark), etc. can be used.

In the overall system 1, the game device 100 can participate in one or a plurality of player groups (hereinafter also abbreviated as "group"). An account of a user using the game device 100 or identification information of the game device 100, etc. may be used for the game device 100 to participate in any group.

A certain game device 100 may belong to only one group at a time, or may belong to a plurality of groups at a time. Hereinafter, as an example, processing in the case of belonging to one group is described. An upper limit may be specified for the number of game devices 100 that can belong to each group.

A game program 240 is stored in the game device (host) 100-1, and by executing the game program 240, it is possible to communicate with one or a plurality of other game devices 100 belonging to a group connected by local wireless communication to execute game processing.

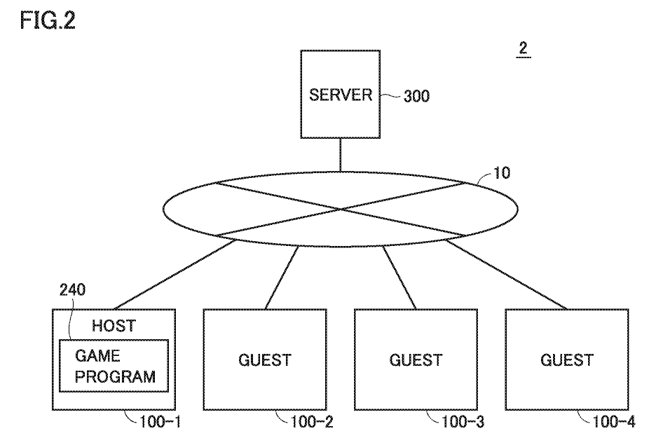

FIG. 2 is a schematic diagram showing another example configuration of an overall system 2 comprising an information processing system according to the present embodiment. Referring to FIG. 2, the overall system 2 shows a configuration example in which four game devices 100-1 to 100-4 are connected via an online connection through a network 10 for Internet communication as another example of a network. Each of the game devices 100 exchanges data with each other via the network 10. In the overall system 2, a communication method for each of the game devices 100 to connect to the network 10 may be a wired method or a wireless method. The overall system 2 may further comprise a management server 300. Each of the game devices 100 may communicate with each other via the management server 300, or may communicate directly with each other (Peer to Peer) without going through the management server 300.

For example, when the game program 240 is capable of multi-person play, the game device (host) 100-1 communicates with the other game devices (guests) 100-2, 100-3, and 100-4. The game device (host) 100-1 executes the game program 240 capable of multi-person play based on an operation input from a player of the own device and operation inputs from the other game devices.

In the present specification, "multi-person play" means that a plurality of players (users) play the same game simultaneously. Alternatively, "multi-person play" means that a plurality of players (users) participate in the same player group. Furthermore, "multi-person play" means that in each of the game devices 100, the game program 240 is executed not only based on operation information of a player on the own device but also based on information from the other game devices 100.

In the present embodiment, the game device (host) 100-1 is configured to execute the game program based on its own operation data and operation data received from the game devices (guests) 100-2, 100-3, and 100-4 to generate a game image, and transmit the generated game image to the game devices (guests) 100-2, 100-3, and 100-4. The game devices (guests) 100-2, 100-3, and 100-4 display the received game image on a display.

Note that all the game devices 100 may hold the game program 240 in advance by an arbitrary method.

The management server 300 is configured to take charge of necessary management of one or a plurality of game devices 100. For example, the management server 300 may perform determination of participation permission or rejection of the game device 100 or a user, etc. The overall system 2 may comprise a plurality of management servers 300. The management server 300 may be a virtual server. Alternatively, a plurality of server devices may constitute the management server 300.

Participation in a group may be performed on a user basis or an account basis. One or a plurality of accounts may be registered in one game device 100. In this case, a user using the game device 100 may select an account each time. Alternatively, an account may be dynamically associated with the game device 100 when the user using the game device 100 operates the game device 100 to access the management server 300, etc. and performs processing such as login.

### B. Flow of Game Processing of Game Device 100

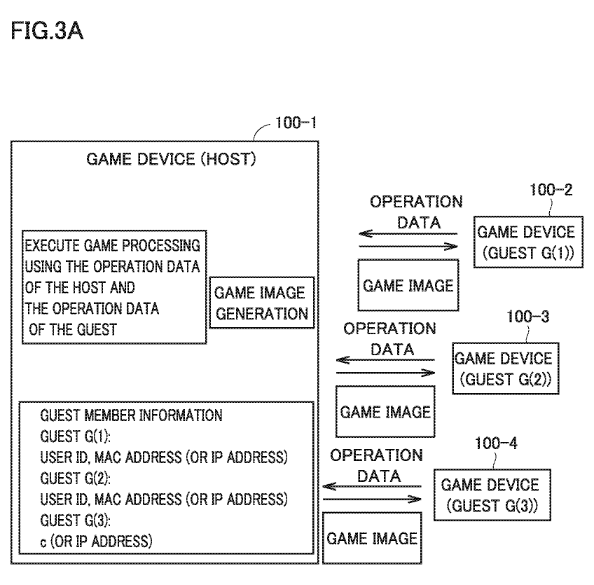

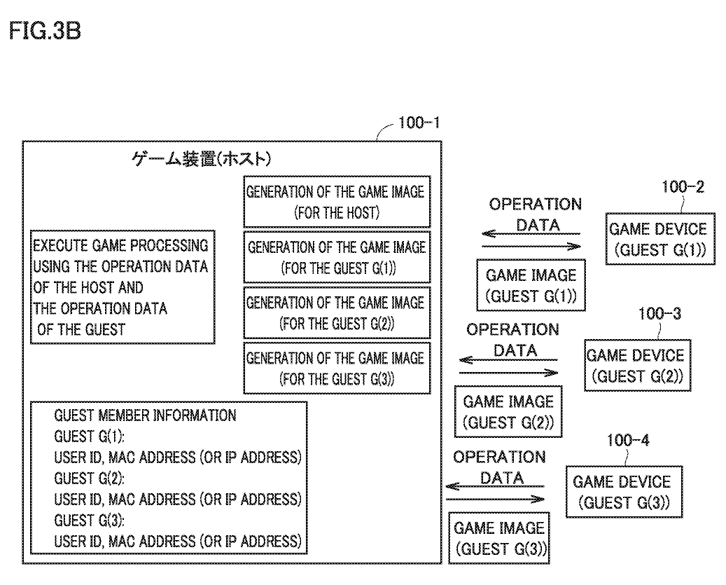

FIGS. 3A and 3B are schematic diagrams of a flow of game processing of the information processing system according to the present embodiment. Referring to FIG. 3A, a flow of game processing in a common image mode of the information processing system is shown as an example. As described above, in the present embodiment, the game device (host) 100-1 generates a game image, and the common image mode is a mode in which the same game image, which is a common game image, is generated by the game device (host) and the game device (guest). The game device (host) 100-1 has guest member information constituting the group. For example, it has information corresponding to guests G(1) to G(3) (also collectively referred to as guest G(i). For example, i is 1 to 3). The guest member information comprises a user ID and a MAC address (or an IP address) corresponding to each of the guests G(1) to G(3). The game device (host) 100-1 is configured to specify the game devices 100-2, 100-3, and 100-4 corresponding to the guests G(1) to G(3) according to the guest member information and execute data communication. In the present embodiment, the game device (host) 100-1 is configured to receive operation data from the game devices 100-2, 100-3, and 100-4 corresponding to the guests G(1) to G(3), respectively. The game device (host) 100-1 is configured to execute game processing using the operation data of the game device (host) 100-1 and the operation data of the game device (guest G(i)). The game device (host) 100-1 is configured to generate a game image (a game image common to the game device (host) and the game device (guest)) by the game processing and transmit the game image to the game devices 100-2, 100-3, and 100-4 corresponding to the guests G(1) to G(3), respectively.

Referring to FIG. 3B, a flow of game processing in an individual image mode of the information processing system is shown as an example. The individual image mode is a mode in which the game device (host) 100-1 generates different game images for the game device (host) and the game device (guest). In the case of the individual image mode, the game image generation processing is different compared to the game processing of the common image mode. For example, a game image for the host of the game device (host) 100-1, a game image for the guest G(1) of the game device 100-2, a game image for the guest G(2) of the game device 100-3, and a game image for the guest G(3) of the game device 100-4 are generated independently. The game device (host) 100-1 is configured to transmit the game images for the guests G(1) to G(3) to the game devices 100-2, 100-3, and 100-4 corresponding to the guests G(1) to G(3), respectively.

### C. Hardware Configuration Example of Game Device 100

Next, an example hardware configuration of the game device 100 according to the present embodiment is described.

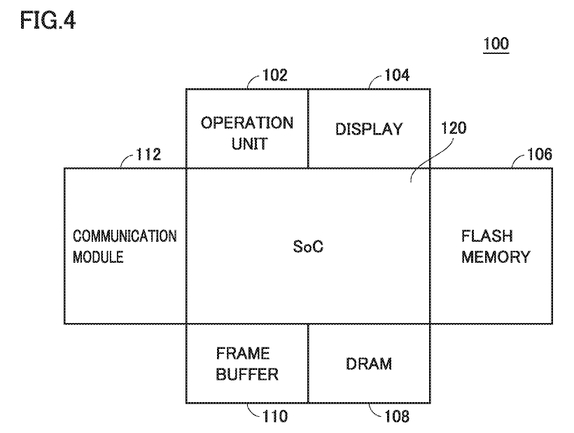

FIG. 4 is a schematic diagram showing an example hardware configuration of the game device 100 according to the present embodiment. The game device 100 is a kind of computer. Referring to FIG. 4, the game device 100 comprises, for example, an operation unit 102, a display 104, a flash memory 106, a DRAM 108, a frame buffer 110, a communication module 112, and an SoC (System on Chip) 120.

The SoC 120 is a processor and is configured to take charge of processing executed in the game device 100. The SoC 120 comprises at least one of, for example, a CPU (Central Processing Unit), a GPU (Graphics Processing Unit), a buffer, etc. For example, the SoC 120 has a VBV buffer used when performing encoding processing (the VBV buffer may be secured in a main memory, etc. outside the SoC 120). A VBV buffer is provided for each guest G(i). The CPU, GPU, buffer, etc. may be mounted independently of each other instead of being mounted on a single board. The SoC 120 may comprise a plurality of CPUs and GPUs, or may have a plurality of cores. In addition to the SoC 120, a hardwired circuit such as an ASIC (Application Specific Integrated Circuit) or an FPGA (Field Programmable Gate Array) may be comprised, and a part of the processing may be performed by those circuits.

The flash memory 106 is a non-volatile storage medium and is a memory mainly used for storing various data to be stored in the game device 100. The flash memory 106 stores a system program 200 and a game program 240, which will be described later. The system program 200 comprises computer-readable instructions for basic processing such as hardware control of the game device 100 and provision of a program execution environment, and also comprises a program for a system application. The game program 240 comprises computer-readable instructions for executing a game.

The DRAM (Dynamic Random Access Memory) 108 is a volatile storage medium and is a memory mainly used for temporarily storing various data used in information processing. The "memory" may comprise at least the flash memory and the DRAM, and may comprise other storage media.

The frame buffer 110 temporarily holds image data to be displayed on the display 104. The SoC 120 is configured to encode image data in frame units, for example, held in the frame buffer 110 by a hardware encoder or a software encoder, and transmit the encoded image data to each game device (guest) 100 via the communication module 112. For example, the SoC 120 is configured to set a bit rate at the time of encoding based on the number of game devices (guests), execute encoding of the game image generated based on the set bit rate, and transmit the encoded game image to the game device (guest), and the game device (guest) is configured to receive the transmitted game image and display the game image on the display.

The operation unit 102 is configured to receive a user operation. The operation unit 102 comprises, for example, a keyboard, a mouse, a game controller, a button, a cross key, a joystick, a touch panel, a motion sensor, etc. The operation unit 102 may be an interface with a device (for example, a game controller) that receives a user operation. The device that receives a user operation may exist outside the game device 100. The operation unit 102 may be provided in a main body of the game device 100, may be a controller detachably provided in the main body of the game device 100, or may be a controller separate from the game device 100.

The communication module 112 is configured to perform data transmission and reception with the other game devices 100, etc. The communication module 112 may be connected to the network 10 by wire or may be connected to the network 10 by wireless. For wired connection, for example, USB (Universal Serial Bus) connection or parallel connection, etc. may be used. For wireless connection, for example, Bluetooth (registered trademark), ZigBee (registered trademark), wireless LAN (IEEE 802.11 standard), etc. may be used.

The display 104 is, for example, an LCD (Liquid Crystal Display), an organic EL display, a television display, a monitor, etc.

For example, the game device (host) 100-1 is configured to receive the operation data of the operation unit 102 of the other game devices (guests) 100-2, 100-3, and 100-4, execute the game program 240 using its own operation data of the operation unit 102 and the received operation data to generate a game image, encode the generated game image in a method in which a bit rate changes, and transmit the encoded game image to the other game devices (guests) 100-2, 100-3, and 100-4. The information processing system is configured to determine display quality of the game image at the game devices (guests) 100-2, 100-3, and 100-4 based on at least one of a communication status in communication of the game image and an encoding bit rate, and display an icon indicating the display quality on a display of the game devices (guests) 100-2, 100-3, and 100-4 along with the game image.

### D. Program Configuration

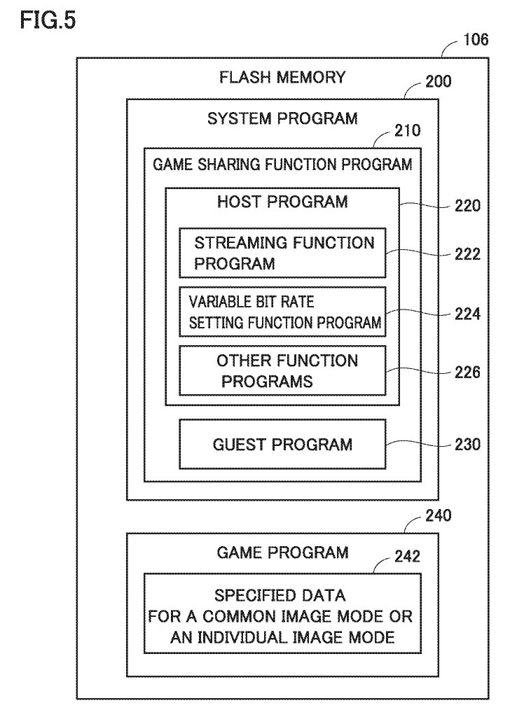

FIG. 5 is a diagram for explaining an example of a program stored in the flash memory 106 of the game device (host) 100-1 according to the present embodiment. Referring to FIG. 5, the flash memory 106 stores a system program 200 and a game program 240.

The system program 200 comprises a game sharing function program 210 that realizes a game sharing function for one game device 100 (host device) to execute the game program 240 and play a game according to the game program 240 with the other game devices 100 (guest devices) (hereinafter referred to as shared play). The game sharing function program 210 comprises a host program 220 for realizing a function of the game device 100 that becomes a host when realizing the game sharing function, and a guest program 230 for realizing a function of the game device 100 that becomes a guest when realizing the game sharing function. The host program 220 comprises a streaming function program 222 for executing processing for streaming transmission of a game image from the game device 100 that becomes a host to the game device 100 that becomes a guest, a variable bit rate setting function program 224 for variably setting a bit rate when executing streaming processing, and other function programs 226 for realizing other functions.

The guest program 230 is configured to perform data transmission and reception with the game device 100 that becomes a host in the game device 100 that becomes a guest to realize the game sharing function of game processing based on the game program 240, and comprises a function of receiving streaming transmission of a game image transmitted from the game device 100 that becomes a host and displaying the game image on a display. For example, each game device (guest G(i)) 100-2, 100-3, and 100-4, by executing the guest program stored in the flash memory 106, can perform game processing according to the game sharing function with the game device (host) 100-1. The guest program 230 may be stored in advance in the flash memory 106 of each game device (guest G(i)) 100-2, 100-3, and 100-4, or may be distributed from the game device 100 that becomes a host, for example, and stored in the flash memory 106 of the game device 100 that becomes a guest.

In the present embodiment, a configuration in which one game program 240 is provided is described, but the present invention is not limited thereto, and a configuration in which a plurality of game programs having a game sharing function are provided may be used. The game program 240 comprises specified data 242 for a common image mode or an individual image mode. By referring to the specified data 242 when executing the game program 240, game processing based on one of the modes is executed. Note that in the present embodiment, the case where the common image mode or the individual image mode is specified in advance according to the game program is described, but the common image mode or the individual image mode may be selected by a user's selection. In the present embodiment, the same program as the system program 200 stored in the flash memory 106 of the game device (host) 100-1 is stored in the flash memory 106 of the game devices (guests) 100-2, 100-3, and 100-4.

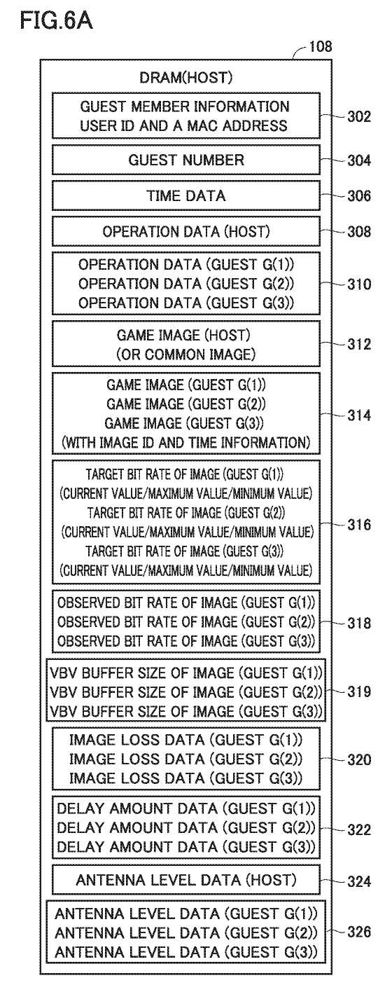

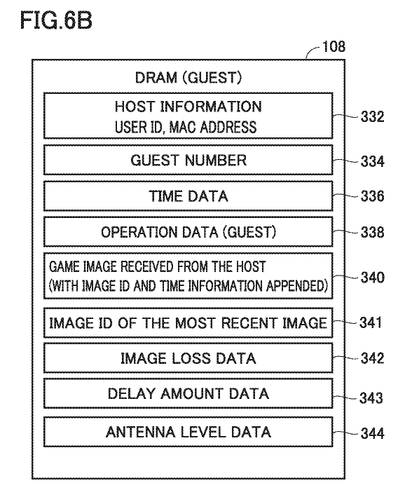

FIGS. 6A and 6B are diagrams for explaining data stored in the DRAM 108 of the game device according to the present embodiment. Referring to FIG. 6A, data of the DRAM 108 on the game device (host) 100-1 side is shown as an example. The DRAM 108 on the game device (host) 100-1 side comprises guest member information 302, guest number 304, time data 306, operation data (host) 308, operation data (each guest G(i)) 310, game image (host) (or common image) 312, game image (each guest G(i)) 314, target bit rate of image (each guest G(i)) 316, observed bit rate of image (each guest G(i)) 318, VBV buffer size of image (each guest G(i)) 319, image loss data (each guest G(i)) 320, delay amount data (each guest G(i)) 322, antenna level data (host) 324, and antenna level data (each guest G(i)) 326.

The guest member information 302 is user information for users who participate in the group as guests in the game processing. As an example, the guest member information 302 comprises a user ID and a MAC address associated with the user ID. The information is stored according to the number of guests participating in the group. For example, the information may be collected and stored in member recruitment processing, which will be described later.

The guest number 304 is the number of users who participate in the group as guests in the game processing. The time data 306 is data related to time and may be used when performing synchronization processing with the other game devices (guests) and calculation processing of a delay amount.

The operation data (host) 308 is data according to an operation of the operation unit 102 on the game device (host) 100-1 side, which is the own device.

The operation data (guest G(i)) 310 is data according to an operation of the operation unit 102 of the other game devices (guests) 100-2, 100-3, and 100-4 received from the other game devices (guests) 100-2, 100-3, and 100-4.

The game image (host) 312 is image data for the host generated based on the game processing.

The game image (guest G(i)) 314 is image data for a guest generated based on the game processing. An image ID is associated with the image data and transmitted. The image ID may be a serial ID of the image that is incremented when the image is transmitted, or a time stamp, etc. may be used as the ID. Note that in the game processing in the common image mode, the image data for the host and the image data for the guest are common, so they may not be generated individually. The game image temporarily stored in the DRAM 108 may be transferred to the frame buffer 110. In the present embodiment, the game image stored in the frame buffer 110 is encoded in a method in which a bit rate changes and transmitted to the other game devices (guests G(i)) 100. In the game processing in the individual image mode, the game image (host) 312 for the host and the game image 314 for the guest are different, but in the game processing in the common image mode, the game image (host) 312 for the host and the game image 314 for the guest are common.

The target bit rate of image (guest G(i)) 316 is a data amount per second of the encoded image data, and encoding is performed so as to become the target bit rate (with the target bit rate as a target). The data comprises a current value, a maximum value, and a minimum value of the target bit rate. In the present embodiment, the current value of the target bit rate is variably set based on the variable bit rate setting function program 224 that variably sets the target bit rate. This target bit rate is sometimes called a set bit rate. Note that the case where the target bit rate is variably set is described, but the target bit rate may be fixedly set.

The observed bit rate of image (guest G(i)) 318 is data obtained by measuring a data amount (bit rate) per second of the image data resulting from the encoding. For example, the observed bit rate of the image can be calculated by measuring a data amount output along a time axis and dividing the data amount by a measurement time. The observed bit rate (guest G(i)) 318 may be used for setting the target bit rate.

The VBV (Video Buffer Verifier) buffer size of image (guest G(i)) 319 is data that defines a VBV buffer size when encoding the image data. The SoC 120 is configured to secure a VBV buffer according to the VBV buffer size and execute encoding processing of the image data for each guest G(i) stored in the frame buffer 110. The encoded image data is transmitted to each game device (guest G(i)) via the communication module 112. For example, it is possible to control quantization by observing a residual information amount (degree of sufficiency) according to the VBV buffer size, and change the bit rate. The encoding processing has a plurality of encoding modes, and an appropriate encoding mode is selected by optimization processing according to the VBV buffer size. In the present embodiment, a VBV buffer is provided for each guest G(i), and the bit rate is changed for each guest G(i).

The image loss data (guest G(i)) 320 is data indicating that the game device (guest) lost an image (that the game image transmitted by the host did not reach the guest). For example, it may comprise an image ID associated with the game images before and after the lost image, or may comprise an image ID of the lost image calculated from the image IDs associated with the game images before and after the lost image. The host is configured to specify that a loss occurred and the lost image based on the data (the lost image is retransmitted). The image loss data (guest G(i)) 320 may be used for setting the target bit rate. It may also be used in generating antenna level data.

The delay amount data (guest G(i)) 322 is a delay time of data transmitted from the game device (host) to the other game devices (guests). The delay amount data (guest G(i)) 322 may be used for setting the target bit rate.

The antenna level data (host) 324 is data used when displaying an icon indicating display quality of the transmitted image data at the game device (guest) to be displayed on the display 104 of the game device (host). For example, in the case of antenna level data L1, an icon with one antenna bar is displayed. In the case of antenna level data L2, an icon with two antenna bars is displayed. In the case of antenna level data L3, an icon with three antenna bars is displayed. In the present embodiment, an icon with three antenna bars is described, but the number of bars is not limited thereto. An icon with a further increased number of antenna bars corresponding to a further plurality of antenna levels being provided may be displayed.

The antenna level data (guest G(i)) 326 is data used for determining the antenna level data (host) 324. For example, the antenna level data (guest G(i)) 326 is data related to image quality at the other game device (guest) of the image data transmitted from the game device (host) to the other game device (guest).

Referring to FIG. 6B, data of the DRAM 108 on the game device (guest G(i)) 100-2, 100-3, and 100-4 side is shown as an example. The DRAM 108 on the guest side comprises host information 332, guest number 334, time data 336, operation data (guest) 338, game image 340 received from the host, image ID 341 of the most recent image, image loss data 342, delay amount data 343, and antenna level data 344.

The host information 332 is user information for a user who participates in the group as a host in the game processing. For example, the host information 332 comprises a user ID and a MAC address associated with the user ID. The information is stored according to the host participating in the group. For example, the information may be collected and stored in member recruitment processing, which will be described later.

The guest number 334 is the number of users who participate in the group as guests in the game processing. The time data 336 is data related to time and may be used when performing synchronization processing with the game device (host) and calculation processing of a delay amount.

The operation data (guest) 338 is data according to an operation of the operation unit 102 on the game device (guest G(i)) side, which is the own device.

The game image 340 received from the host is the game image 314 for the guest G(i) generated by the host based on the game processing described in FIG. 6A and transmitted from the host to the guest. Note that in the game processing in the common image mode, the game image 340 is a common image and is the same as the game image (host) 312. An image ID and time information of the image are associated with the image data and appended.

The image ID 341 of the most recent image is data related to the image ID associated with the game image most recently received from the host.

The image loss data 342 is data indicating that the game device (guest) lost an image. For example, it comprises data related to the image ID corresponding to the lost image. The image loss data 342 can be specified by comparing the image ID 341 of the most recent image with the image ID associated with the game image currently received from the host. For example, by checking the image ID 341 of the most recent image, if the image IDs are arriving in sequence, no image loss has occurred. On the other hand, by checking the image ID 341 of the most recent image, if the image IDs are not in sequence and there is a gap, it is possible to specify that an image loss corresponding to the missing image ID has occurred. The game devices (guests G(i)) 100-2, 100-3, and 100-4 are configured to transmit the image loss data 342 corresponding to the missing image ID to the game device (host) 100-1. The game device (host) 100-1 is configured to store the image loss data 342 corresponding to each guest G(i) as the image loss data 320 in the DRAM 108.

The delay amount data 343 is data related to a delay amount based on the time information appended to the received image data and the current time data 336. For example, the delay amount may be calculated by a difference between the time information appended to the image data and the current time data 336.

The antenna level data 344 is data used when displaying an icon indicating display quality of the received image data to be displayed on the display 104 of the game device (guest). For example, in the case of antenna level data L1, an icon with one antenna bar is displayed. In the case of antenna level data L2, an icon with two antenna bars is displayed. In the case of antenna level data L3, an icon with three antenna bars is displayed. In the present embodiment, an icon with three antenna bars is described, but the number of bars is not limited thereto. An icon with a further increased number of antenna bars corresponding to a further plurality of antenna levels being provided may be displayed. The antenna level data 344 may be data calculated based on antenna level calculation/display processing, which will be described later, for example.

### E. Processing Flow

Hereinafter, some processing of the embodiment is described. Note that the processing may comprise other processing or may not comprise a part of the processing. The order of each processing is an example, and for example, each processing may be executed simultaneously or may be executed in the reverse order. Each processing is described as being divided for convenience, but it may be integrated processing.

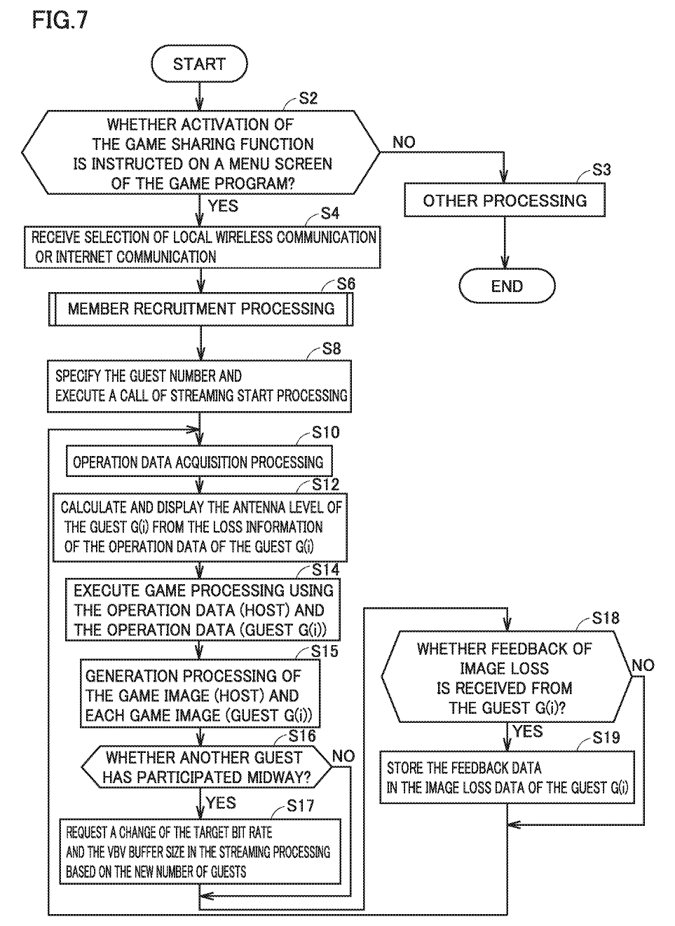

FIG. 7 is a flow diagram for explaining game processing of the game device (host) according to the present embodiment. The processing procedure shown in FIG. 7 is realized by the SoC 120 of the game device (host) 100-1 reading and executing the game program 240 stored in the flash memory 106.

Referring to FIG. 7, the SoC 120 is configured to determine whether activation of the game sharing function is instructed on a menu screen of the game program (step S2). In step S2, a specification of the common image mode or the individual image mode is performed in the system program.

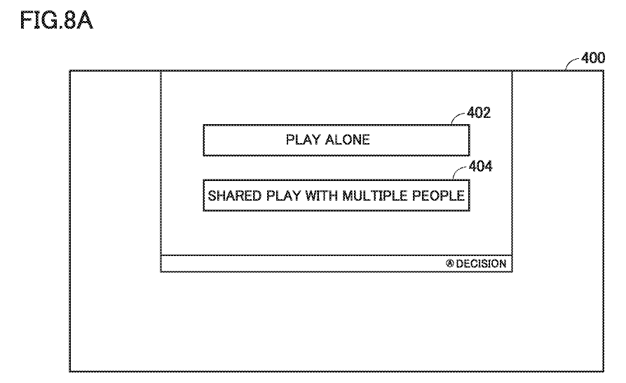

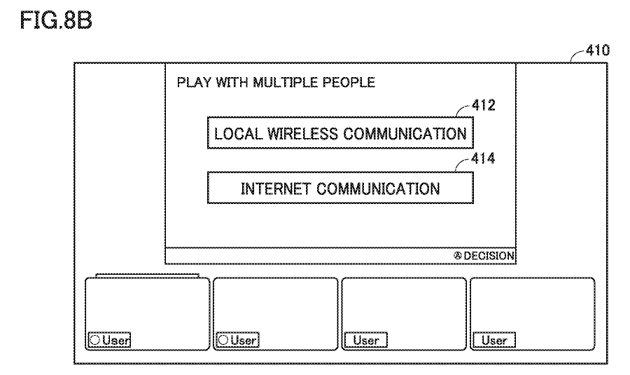

FIGS. 8A and 8B are diagrams for explaining a menu screen according to the present embodiment. Referring to FIG. 8A, the case where a menu screen 400 is displayed on the display 104 is shown. The menu screen 400 is provided with a "play alone" icon 402 and a "shared play with multiple people" icon 404, which are configured to receive a user's selection input. A user can select one of the icons by operating the operation unit 102. For example, the SoC 120 may determine that activation of the game sharing function is instructed when the user selects the "shared play with multiple people" icon 404.

Referring to FIG. 8B, the case where another menu screen 410 is displayed on the display 104 is shown. The menu screen 410 is provided with a "local wireless communication" icon 412 and an "Internet communication" icon 414, which are configured to receive a user's selection input. A user can select one of the icons by operating the operation unit 102. For example, the SoC 120 may determine that activation of the game sharing function is instructed by local wireless communication when the user selects the "local wireless communication" icon 412. For example, the game device (host) 100-1 operates to construct an overall system in which the game device (host) 100-1 is connected to the other game devices (guests) 100-2, etc. by local wireless communication, as described in FIG. 1.

The SoC 120 may determine that activation of the game sharing function is instructed by Internet communication when the user selects the "Internet communication" icon 414. For example, the game device (host) 100-1 operates to construct an overall system in which a plurality of game devices 100 are connected via an online connection using the network 10 for Internet communication, as described in FIG. 2.

Referring to FIG. 7 again, in step S2, when the SoC 120 determines that activation of the game sharing function is instructed (YES in step S2), the SoC 120 is configured to receive a selection of local wireless communication or Internet communication (step S4). For example, a selection input of communication from a user is received as described in FIG. 8B. In step S4, the selected communication method is notified to the system program.

On the other hand, in step S2, when the SoC 120 determines that activation of the game sharing function is not instructed (NO in step S2), the SoC 120 executes other processing (step S3). Then, the processing is terminated (end). For example, in FIG. 8A, when the "play alone" icon 402 is selected, game processing by a single person based on the game program 240 may be executed without activating the game sharing function.

Next, the SoC 120 executes member recruitment processing (step S6). For example, in the member recruitment processing, members of the group may be recruited until an upper limit value of the number of guests supported by the game program is reached, or the processing may be interrupted even if the number of guests does not reach the upper limit value.

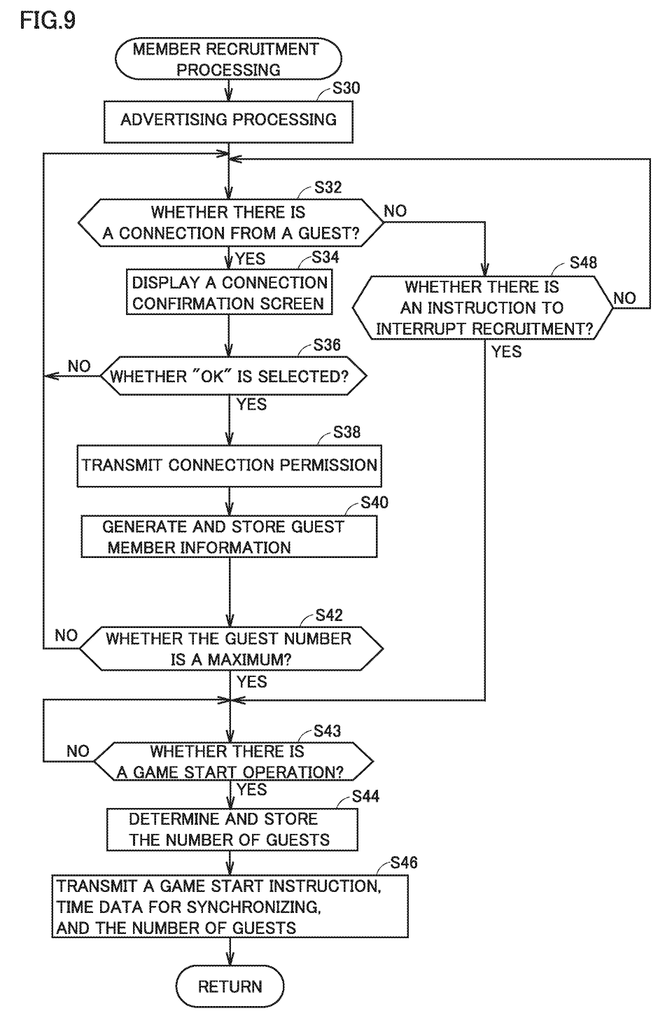

FIG. 9 is a subroutine flow diagram of member recruitment processing according to the present embodiment. Referring to FIG. 9, there are various methods for the member recruitment processing, but a case of local wireless communication is described as an example. The SoC 120 of the game device (host) 100-1 executes advertising processing (step S30). The game device (host) 100-1 is configured to wait for a connection from the other game devices (guest G) 100-2, etc. by a guest by the advertising processing.

Next, the SoC 120 determines whether there is a connection from a guest (step S32). In step S32, when the SoC 120 determines that there is a connection from a guest (YES in step S32), the SoC 120 is configured to display a connection confirmation screen for selecting whether connection is permitted according to the guest information on the display 104.

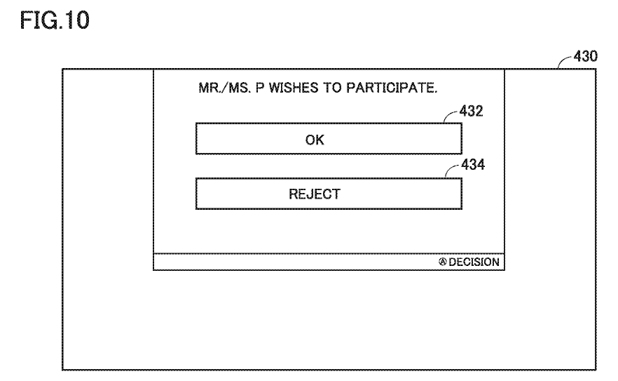

FIG. 10 is a diagram for explaining an example of a connection confirmation screen according to the present embodiment. Referring to FIG. 10, the connection confirmation screen 430 is provided with an "OK" button 432 for permitting connection and a "reject" button 434 for rejecting connection, for example, along with a comment "Mr./Ms. P wishes to participate." For example, when a user who is the host selects the "OK" button 432 on the connection confirmation screen 430, the connection of the game device 100 of the guest who wished to connect (for example, Mr./Ms. P) is permitted. On the other hand, when the "reject" button 434 is selected on the connection confirmation screen 430, the connection of the game device 100 of the guest who wished to connect (for example, Mr./Ms. P) is rejected.

Referring to FIG. 9 again, the SoC 120 determines whether "OK" is selected by the user who is the host on the connection confirmation screen 430 (step S36).

In step S36, when the SoC 120 determines that "OK" is selected by the user who is the host on the connection confirmation screen 430 (YES in step S36), the SoC 120 is configured to transmit connection permission to the game device 100 of the guest who wished to connect (for example, Mr./Ms. P) (step S38). For example, the connection permission comprises host information. The host information is data comprising the user ID and MAC address data of the game device that is the host. The game device (guest) 100 that receives the connection permission is configured to store the host information 332 in the DRAM 108 based on the data.

Next, the SoC 120 generates and stores guest member information (step S40). For example, the SoC 120 is configured to generate and register necessary information as the guest member information 302 in the DRAM (host) 108. As an example, the SoC 120 stores the user ID of the guest who wished to connect and the MAC address associated with the user ID. The user ID and the MAC address are data acquired from the game device 100 of the guest who wished to connect during the advertising processing.

Next, the SoC 120 determines whether the guest number 304 is a maximum (upper limit value) of the number of guests supported by the game program (step S42).

In step S42, when the SoC 120 determines that the guest number 304 is not the maximum (upper limit value) of the number of guests supported by the game program (NO in step S42), the processing returns to step S32 and repeats the above processing.

On the other hand, in step S42, when the SoC 120 determines that the guest number 304 is the maximum (upper limit value) of the number of guests supported by the game program (YES in step S42), the SoC 120 determines whether there is a game start operation (step S43). For example, when there is an operation input for starting the game by the user who is the host, it is determined that there is a game start operation.

In step S43, when the SoC 120 determines that the game start operation is not performed (NO in step S43), the state is maintained. Alternatively, if the game start operation is canceled, the processing may return to the initial menu screen.

On the other hand, in step S43, when the SoC 120 determines that there is a game start operation (YES in step S43), the SoC 120 determines and stores the number of guests (step S44). For example, the SoC 120 is configured to determine and store the number of guests based on the guest member information 302. If there is one set of user ID and MAC address data, the number of guests is 1; if there are two sets of user ID and MAC address data, the number of guests is 2; and if there are three sets of user ID and MAC address data, the number of guests is 3. The SoC 120 stores the counted number of guests as the guest number 304.

Next, the SoC 120 executes processing for transmitting a game start instruction, time data for synchronizing time data with each guest, and the number of guests to each guest (step S46). For example, the SoC 120 of the game device (host) 100-1 is configured to transmit the guest number 304 and the time data 306 to the game devices (guests) 100-2, 100-3, and 100-4 along with the game start instruction. The game devices (guests) 100-2, 100-3, and 100-4 receive the time data 306 and synchronize the time. This eliminates variation in time, making it possible to calculate a delay amount, etc. with high accuracy. The game devices (guests) 100-2, 100-3, and 100-4 store the guest number 304 as the guest number 334.

Then, the processing is terminated (return). On the other hand, in step S36, when the SoC 120 determines that "OK" is not selected by the user who is the host on the connection confirmation screen 430, that is, determines that "reject" is selected by the user who is the host (NO in step S36), the SoC 120 stops the connection to the game device 100 of the guest who wished to connect (for example, Mr./Ms. P) and does not transmit the game start instruction, etc. In this case, the processing returns to step S32 again.

In step S32, when the SoC 120 determines that there is no connection from a guest (NO in step S32), the SoC 120 determines whether there is an instruction to interrupt recruitment (step S48).

In step S48, when the SoC 120 determines that there is an instruction to interrupt recruitment (YES in step S48), the processing proceeds to step S43, and the SoC 120 determines whether there is a game start operation. For example, it may be determined that there is an instruction to interrupt the member recruitment processing when a specified period has elapsed since the member recruitment processing started. Alternatively, it may be determined that there is an instruction to interrupt recruitment according to an operation instruction from a user.

On the other hand, in step S48, when the SoC 120 determines that there is no instruction to interrupt recruitment (NO in step S48), the processing returns to step S32 and repeats the above processing.

The member recruitment processing in the case of local wireless communication has been described above, but for example, in the case of Internet communication, member recruitment processing using the management server 300 may be executed. For example, the host requests the management server 300 to generate a matching room, the management server 300 generates a matching room and recruits guests, and when the matching processing is terminated, the management server 300 transmits guest member information to the game device (host), and the game device (host) transmits necessary data to each game device (guest). For example, the host information, the guest number, and the time data may be transmitted from the game device (host) to each game device (guest) along with a connection and game start instruction. Note that the host information, the guest number, and the time data may be transmitted from the management server 300 to the game device (guest G(i)) along with a connection and game start instruction. Note that in the case of Internet communication, an IP address may be used instead of the MAC address comprised in the guest member information and the host information.

Referring to FIG. 7 again, the SoC 120 specifies the guest number 304 and executes a call of streaming start processing (step S8). For example, the SoC 120 calls the streaming function program 222 comprised in the game sharing function program 210 of the flash memory 106 and starts streaming processing. The streaming processing according to the streaming function program 222 will be described later.

Next, the SoC 120 executes operation data acquisition processing (step S10). The SoC 120 is configured to refer to the guest member information 302, receive the operation data for each guest transmitted from the corresponding game device (guest) by local wireless communication or Internet communication, and store the operation data 310 in the DRAM 108 for each guest (G(i)).

Next, the SoC 120 calculates and displays the antenna level of the guest G from the loss information of the operation data of the guest G (step S12). The SoC 120 is configured to calculate the antenna level of the guest G from the guest operation data (loss information) that could not be acquired in the operation data acquisition processing in step S10. For example, the SoC 120 calculates the antenna level based on loss information (a number of losses as an example) of the operation data (guest G(i)) per unit time. The SoC 120 may determine the level L1 if the number of losses of the operation data per unit time is a specified value m or more. The SoC 120 may determine the level L2 if the loss information of the operation data per unit time is a specified value n (m > n) or more. The SoC 120 may determine the level L3 if the loss information of the operation data per unit time is less than the specified value n. The SoC 120 stores the determined level as the antenna level data (guest G(i)) 326.

The SoC 120 stores the minimum value of the antenna level of each guest G(i) comprised in the antenna level data (guest G(i)) 326 as the antenna level data (host) 324. For example, when the antenna level data (guest G(1)) 326 is the level L3, the antenna level data (guest G(2)) 326 is the level L2, and the antenna level data (guest G(3)) 326 is the level L1, the antenna level data (host) 324 may be the level L1. The SoC 120 is configured to display an icon indicating display quality of the transmitted image data on the display 104 of the game device (host) 100 according to the antenna level data (host) 324. For example, in the case of the antenna level data L1, an icon with one antenna bar is displayed. In the case of the antenna level data L2, an icon with two antenna bars is displayed. In the case of the antenna level data L3, an icon with three antenna bars is displayed.

Next, the SoC 120 executes game processing based on the game program 240 using the operation data (host) 308 and the operation data (guest G(i)) 310 (step S14).

Next, the SoC 120 executes generation processing of the game image (host) and each game image (guest G(i)) (step S15). The SoC 120 stores the generated game image on the host side as the game image (host) 312. The SoC 120 stores the generated game image on each guest (G(i)) side as the game image (guest G(i)) 314. An image ID and time information issued when the image is generated are associated with the game image and stored. In the present embodiment, generation processing in the case of game processing in the individual image mode is described, but in the game processing in the common image mode, a game image common to the host and the guest may be stored as the game image 312.

Next, the SoC 120 determines whether another guest has participated midway (step S16).

In step S16, when the SoC 120 determines that another guest has participated midway (YES in step S16), the SoC 120 requests a change of the target bit rate and the VBV buffer size based on the new number of guests in the streaming processing according to the streaming function program 222 (step S17). For example, in the case of a game program that receives a guest's midway participation during game processing, when there is a guest's midway participation, the guest member information 302 and the guest number 304 of the DRAM 108 of the game device (host) 100-1 are updated according to the method described in FIG. 9. Also, the guest number 334 of the DRAM 108 of the game device (guest) 100 is updated.

On the other hand, in step S16, when the SoC 120 determines that another guest has not participated midway (NO in step S16), the SoC 120 skips step S17.

Next, the SoC 120 determines whether feedback of image loss is received from the guest G(i) (step S18).

In step S18, when the SoC 120 determines that feedback of image loss is received from the guest G(i) (YES in step S18), the SoC 120 stores the feedback data in the image loss data of the guest G(i) (step S19). For example, when the SoC 120 receives information on the lost image ID from the guest G(i) as feedback of image loss, the SoC 120 stores the information on the image ID as the image loss data 320.

Then, the processing returns to step S10 again and repeats the above processing. On the other hand, in step S18, when the SoC 120 determines that feedback of image loss is not received from the guest G(i) (NO in step S18), the SoC 120 skips step S19 and returns to step S10.

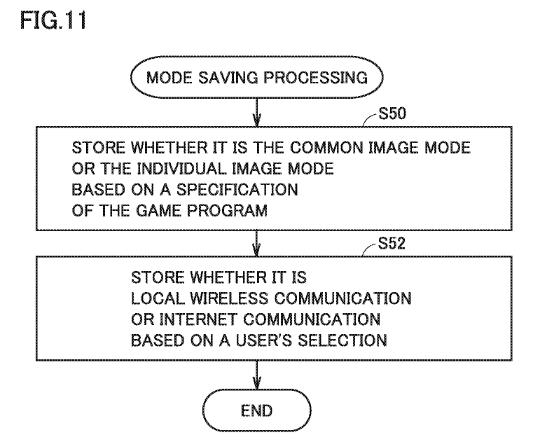

FIG. 11 is a flow diagram for explaining mode saving processing in the game sharing function according to the present embodiment. The mode saving processing is realized by reading and executing the host program 220 in the flash memory 106.

The SoC 120 is configured to store whether it is the common image mode or the individual image mode based on a specification of the game program (the specification in S2 of FIG. 7 described above) (step S50). For example, the SoC 120 stores whether the game sharing function is in the common image mode or the individual image mode based on the specified data 242 comprised in the game program 240.

Next, the SoC 120 is configured to store whether it is local wireless communication or Internet communication based on a user's selection (notification based on the selection in S4 of FIG. 7 described above) (step S52). For example, when the user selects the "local wireless communication" icon 412 as described in FIG. 8B, the SoC 120 stores that local wireless communication is instructed in the game sharing function. On the other hand, when the user selects the "Internet communication" icon 414, the SoC 120 stores that Internet communication is instructed in the game sharing function. Then, the processing is terminated (end).

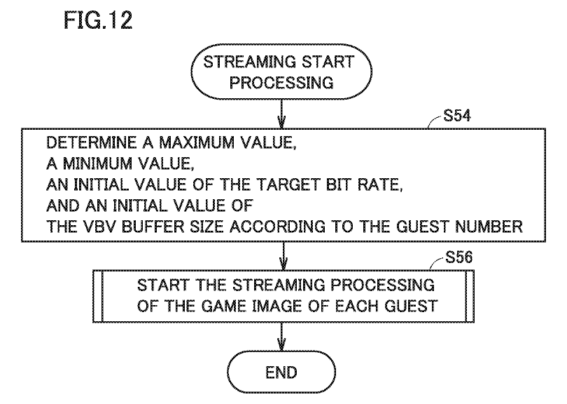

FIG. 12 is a flow diagram for explaining streaming start processing according to the present embodiment. Referring to FIG. 12, the SoC 120 executes a streaming start processing program (comprised in the streaming function program 222) according to the call of the streaming start processing described in step S8 and executes the streaming start processing.

Specifically, the SoC 120 determines a maximum value, a minimum value, an initial value of the target bit rate, and an initial value of the VBV buffer size according to the guest number 304 (step S54). For example, when the guest number 304 is "3," the maximum value of the target bit rate may be determined as 3 Mbps; when the guest number 304 is "2," the maximum value of the target bit rate may be determined as 4 Mbps; and when the guest number 304 is "1," the maximum value of the target bit rate may be determined as 5 Mbps. For example, the minimum value of the target bit rate may be determined as the same 0.1 Mbps for all cases, or may be determined according to the guest number 304. For example, the initial value of the target bit rate may be set to the maximum value. The initial value of the VBV buffer size may be determined as 1.5M when the guest number 304 is "3," 2M when the guest number 304 is "2," and 2.5M when the guest number 304 is "1." As an example, the case where the maximum value, the minimum value, the initial value of the target bit rate, and the initial value of the VBV buffer size are determined according to the number of guests has been described, but the number of guests may be determined as the upper limit value of the number of guests supported by the game program. It is possible to statically correspond to a game device (guest) that participates midway during game processing.

In the present embodiment, since the initial value of the VBV buffer size is set according to the number of guests or the upper limit value thereof, the VBV buffer size can be appropriately set.

The SoC 120 stores the data determined for each guest G(i) in the target bit rate of image (guest G(i)) 316 and the VBV buffer size of image (guest G(i)) 319. The initial value is set as the current value.

Next, the SoC 120 starts the streaming processing of the game image of each guest G(i) according to the determination (step S56). Details of the streaming processing will be described later. Then, the processing is terminated (end).

Note that in step S54, the processing of changing the maximum value, etc. of the target bit rate according to the guest number 304 has been described, but in the case of Internet communication, which has a margin in the communication path, this processing may be executed or may not be executed.

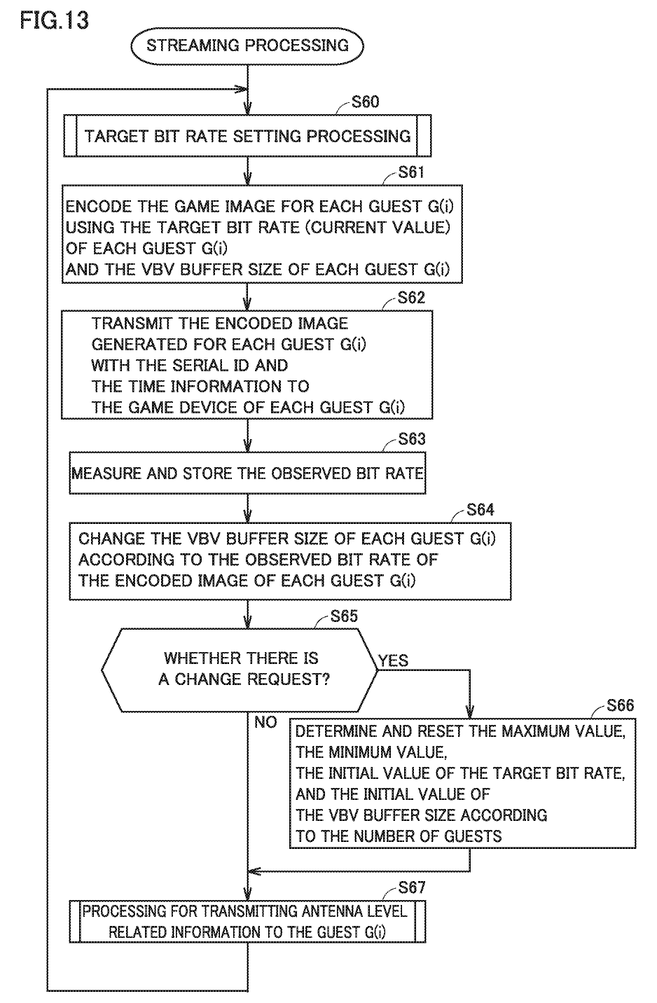

FIG. 13 is a subroutine flow diagram of streaming processing according to the present embodiment. The streaming processing is realized by the SoC 120 executing the streaming function program. Referring to FIG. 13, the SoC 120 executes target bit rate setting processing (step S60). The target bit rate setting processing is executed for each guest G(i).

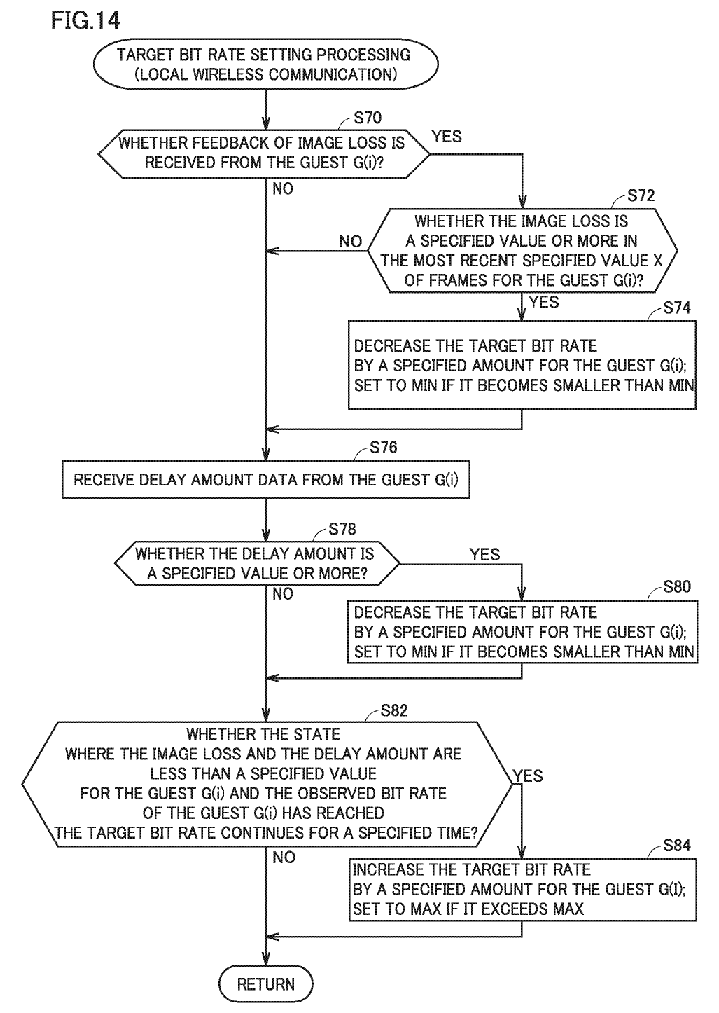

FIG. 14 is another subroutine flow diagram of target bit rate setting processing according to the present embodiment. Referring to FIG. 14, the case of local wireless communication is described here. The SoC 120 determines whether feedback of image loss is received from the guest G(i) (step S70). For example, the SoC 120 refers to the image loss data 320 and determines whether image loss corresponding to the guest G(i) is stored. In step S70, when the SoC 120 determines that feedback of image loss is received (YES in step S70), the SoC 120 determines whether the image loss is a specified value or more in the most recent specified value X of frames for the guest G(i) (step S72). The specified value X may be set to an arbitrary value of 1 or more. For example, the host-side game device (host) 100 is configured to divide the game image of one frame into a plurality of communication packets and transmit the communication packets. The guest-side game device (guest) 100 is configured to determine whether all the transmitted communication packets are received, and when even one communication packet out of the plurality of communication packets is lost, the guest-side game device (guest) 100 is configured to transmit feedback of the image loss of the frame (image ID).

In step S72, when the SoC 120 determines that the image loss is the specified value or more in the most recent specified value X of frames for the guest G(i) (YES in step S72), the SoC 120 is configured to decrease the target bit rate by a specified amount for the guest G(i) (step S74). When the target bit rate becomes smaller than the lower limit value Min, the SoC 120 sets the target bit rate to the lower limit value Min. Next, the processing proceeds to step S76.

On the other hand, in step S72, when the SoC 120 determines that the image loss is less than the specified value in the most recent specified value X of frames for the guest G(i) (NO in step S72), or when the SoC 120 determines that feedback of image loss is not received from the guest G(i) (NO in step S70), the processing proceeds to step S76.

In step S76, the SoC 120 receives delay amount data from the guest G(i) (step S76). For example, the SoC 120 is configured to receive the delay amount data transmitted from the game device 100 of the guest G(i) and store the delay amount data in the DRAM 108 as the delay amount data 322.

Next, the SoC 120 determines whether the delay amount is a specified value or more based on the delay amount data 322 of the guest G(i) stored in the DRAM 108 (step S78). In step S78, when the SoC 120 determines that the delay amount is the specified value or more for the guest G(i) (YES in step S78), the SoC 120 is configured to decrease the target bit rate by a specified amount for the guest G(i) (step S80). When the target bit rate becomes smaller than the lower limit value Min, the SoC 120 sets the target bit rate to the lower limit value Min. Next, the processing proceeds to step S82. Note that the SoC 120 is not limited to determining whether the delay amount is the specified value or more based on the delay amount data 322 of the guest G(i) stored in the DRAM 108, but may determine whether an increase amount of the delay is a specified value or more.

On the other hand, in step S78, when the SoC 120 determines that the delay amount is not the specified value or more for the guest G(i) (NO in step S78), the processing proceeds to step S82.

Next, the SoC 120 determines whether the state where the image loss and the delay amount are less than a specified value for the guest G(i) and the observed bit rate of the guest G(i) has reached the target bit rate continues for a specified time (step S82).

In step S82, when the SoC 120 determines that the state where the image loss and the delay amount are less than the specified value for the guest G(i) and the observed bit rate of the guest G(i) has reached the target bit rate continues for the specified time (YES in step S82), the SoC 120 is configured to increase the target bit rate by a specified amount for the guest G(i) (step S84). When the target bit rate exceeds the upper limit value Max, the SoC 120 sets the target bit rate to the upper limit value Max. Then, the processing is terminated (return).

In step S82, when the SoC 120 determines that the state where the image loss and the delay amount are less than the specified value for the guest G(i) and the observed bit rate of the guest G(i) has reached the target bit rate does not continue for the specified time (NO in step S82), the SoC 120 skips step S84 and terminates the processing (return).

The state where the image loss and the delay amount are less than the specified value is a state where the communication status is stable. The state where the observed bit rate has reached the target bit rate continues for the specified time is a state where the state of transmitting the information amount of the current game image at the appropriate target bit rate continues for the specified time. In these states, the target bit rate is increased by a specified amount.

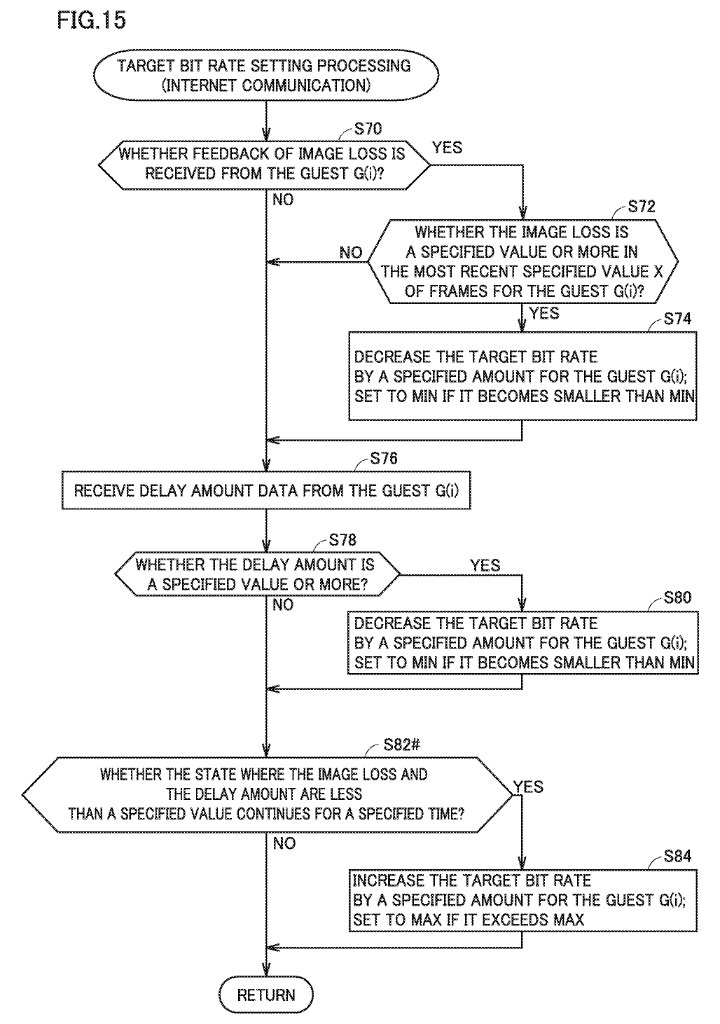

FIG. 15 is another subroutine flow diagram of target bit rate setting processing according to the present embodiment. Referring to FIG. 15, the case of Internet communication is described here. The difference from the flow diagram of FIG. 14 is that step S82 is replaced by step S82#. The other processing is the same as that described in FIG. 14, so a detailed description thereof is not repeated.

In step S82#, the SoC 120 determines whether the state where the image loss and the delay amount are less than a specified value continues for a specified time (step S82#).

In step S82#, when the SoC 120 determines that the state where the image loss and the delay amount are less than the specified value continues for the specified time for the guest G(i) (YES in step S82#), the SoC 120 is configured to increase the target bit rate by a specified amount for the guest G(i) (step S84). When the target bit rate exceeds the upper limit value Max, the SoC 120 sets the target bit rate to the upper limit value Max. Then, the processing is terminated (return).

In step S82#, when the SoC 120 determines that the state where the image loss and the delay amount are less than the specified value does not continue for the specified time for the guest G(i) (NO in step S82#), the SoC 120 skips step S84 and terminates the processing (return).

The state where the image loss and the delay amount are less than the specified value is a state where the communication status is stable. In the case of Internet communication, the target bit rate is increased by a specified amount in this state. When the image changes from a simple game image to a complex game image, in the case of Internet communication, even if the target bit rate and the observed bit rate rapidly diverge and the load on the communication path fluctuates greatly, the increase in image loss and delay amount is unlikely to occur because there is a margin in the communication path. On the other hand, in the case of local wireless communication, a sudden load fluctuation on the communication path may cause an increase in image loss and delay amount because there is a restriction on the communication path. Therefore, in the case of local wireless communication, the rapid divergence between the target bit rate and the observed bit rate is suppressed by setting the condition that the state of transmitting the information amount of the current game image at the appropriate target bit rate continues for a specified time. Note that this condition may be added even in the case of Internet communication.

As described above, in the present embodiment, the target bit rate for encoding is set according to the number of guests or the upper limit value thereof. This makes it possible to efficiently use the limited communication bandwidth to transmit the game image generated by the host to the guest.

If the target bit rate is set according to the upper limit value of the guest, it is possible to handle midway participation of a guest without difficulty.

Further, since the initial value of the target bit rate is set according to the number of guests or the upper limit value thereof, and then the target bit rate is varied according to each factor, it is possible to correspond to the situation after the start of play. In this case as well, the maximum target bit rate is determined according to the number of guests or the upper limit value thereof, and the bit rate does not exceed that. Therefore, the target bit rate can be set within a range according to the number of guests or the upper limit value thereof.

Referring to FIG. 13 again, next, the SoC 120 is configured to encode the image for each guest G(i) using the target bit rate (current value) of each guest G(i) and the VBV buffer size of each guest G(i) (step S61). The SoC 120 encodes the image for each guest G(i) in a method in which a bit rate changes. The encoding may be performed in a method in which the target bit rate at the time of encoding fluctuates according to the communication status. The encoding may be performed in a method in which the observed bit rate (resulting bit rate) resulting from the encoding fluctuates according to the information amount of the image for each guest G(i). The encoding may be performed in a method in which the set bit rate at the time of encoding is increased based on a comparison between the target bit rate at the time of encoding and the observed bit rate resulting from the encoding. For example, the SoC 120 executes encoding processing of the image data stored in the frame buffer 110 according to the target bit rate and the VBV buffer size. The SoC 120 selects an appropriate encoding mode by optimization processing according to the target bit rate and the remaining residual amount of the VBV buffer size, and executes encoding processing according to the selected encoding mode.

Next, the SoC 120 is configured to transmit the encoded image generated for each guest G(i) with the image ID and the time information appended to the game device 100 of each guest G(i) (step S62).

Next, the SoC 120 measures and stores the observed bit rate (step S63). The SoC 120 measures and stores the bit rate of the transmitted data (resulting bit rate) resulting from the encoding as the observed bit rate. For example, the SoC 120 can calculate the bit rate by measuring the amount of transmitted data output along the time axis and dividing the amount by the measurement time. The SoC 120 stores the calculated measured bit rate as the observed bit rate of image (guest G(i)) 318.

Next, the SoC 120 changes the VBV buffer size of each guest G(i) according to the observed bit rate of the encoded image of each guest (step S64).

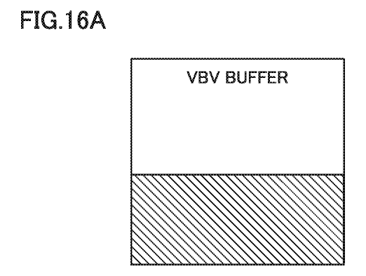

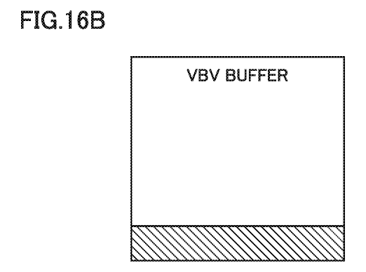

FIGS. 16A and 16B are diagrams for explaining a change in VBV buffer size according to the present embodiment. Referring to FIG. 16A, an initial value of the VBV buffer size is shown as an example. The SoC 120 sets the initial value of the VBV buffer size based on the guest number 304. The SoC 120 changes the value of the VBV buffer size for each guest G(i) for each game device (guest G(i)) based on the bit rate (observed bit rate) resulting from the encoding executed on the game image of the game device (guest G(i)). For example, as shown in FIG. 16B, the value of the VBV buffer size may be set to 1/2 of the observed bit rate for each game device (guest G(i)). The SoC 120 stores the changed value of the VBV buffer size as the VBV buffer size (guest G(i)) 319.

Referring to FIG. 13 again, next, the SoC 120 determines whether there is a change request (step S65). The SoC 120 determines whether there was a change request as the processing in step S17 of FIG. 7.

In step S65, when the SoC 120 determines that there is a change request (YES in step S65), the SoC 120 determines and resets the maximum value, the minimum value, the initial value of the target bit rate, and the initial value of the VBV buffer size according to the number of guests (step S66). Then, the processing proceeds to step S67.

On the other hand, in step S65, when the SoC 120 determines that there is no change request (NO in step S65), the SoC 120 skips step S66 and proceeds to step S67.

In step S67, the SoC 120 executes processing for transmitting antenna level related information to the guest G(i) (step S67). Details of the processing for transmitting antenna level related information to the guest G(i) will be described later.

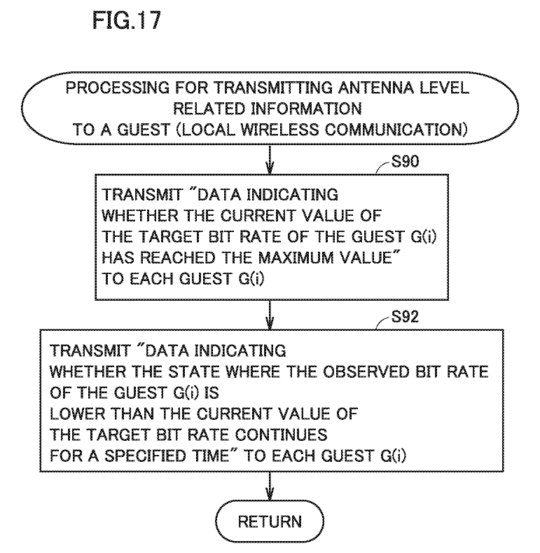

Then, the processing returns to step S60 and repeats the above processing. FIG. 17 is a subroutine flow diagram of processing for transmitting antenna level related information to a guest G(i) according to the present embodiment. Referring to FIG. 17, the case of local wireless communication is described here. The SoC 120 is configured to transmit "data indicating whether the current value of the target bit rate of the guest G(i) has reached the maximum value" to the guest G(i) (step S90). For example, the "data indicating whether the current value of the target bit rate of the guest G(i) has reached the maximum value" is flag information of "0" or "1."

Next, the SoC 120 is configured to transmit "data indicating whether the state where the observed bit rate of the guest G(i) is lower than the current value of the target bit rate continues for a specified time" to the guest G(i) (step S92). For example, the "data indicating whether the state where the observed bit rate of the guest G(i) is lower than the current value of the target bit rate continues for a specified time" is flag information of "0" or "1."

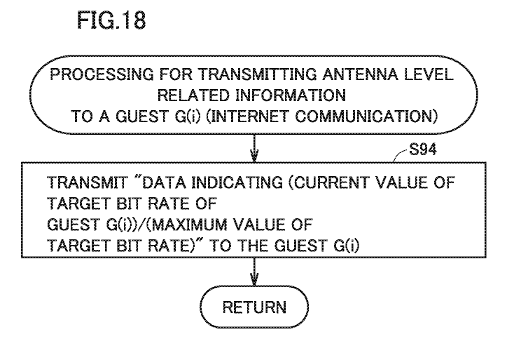

Then, the processing is terminated (return). FIG. 18 is another subroutine flow diagram of processing for transmitting antenna level related information to a guest G(i) according to the present embodiment. Referring to FIG. 18, the case of Internet communication is described here. The SoC 120 is configured to calculate "(current value of target bit rate of guest G(i))/(maximum value of target bit rate)" for each guest G(i) and transmit data indicating the calculation result value to the guest G(i) (step S94).

Then, the processing is terminated (return). The processing for transmitting antenna level related information to the guest G(i) may be executed at specified period intervals. For example, it may be performed once every few seconds.

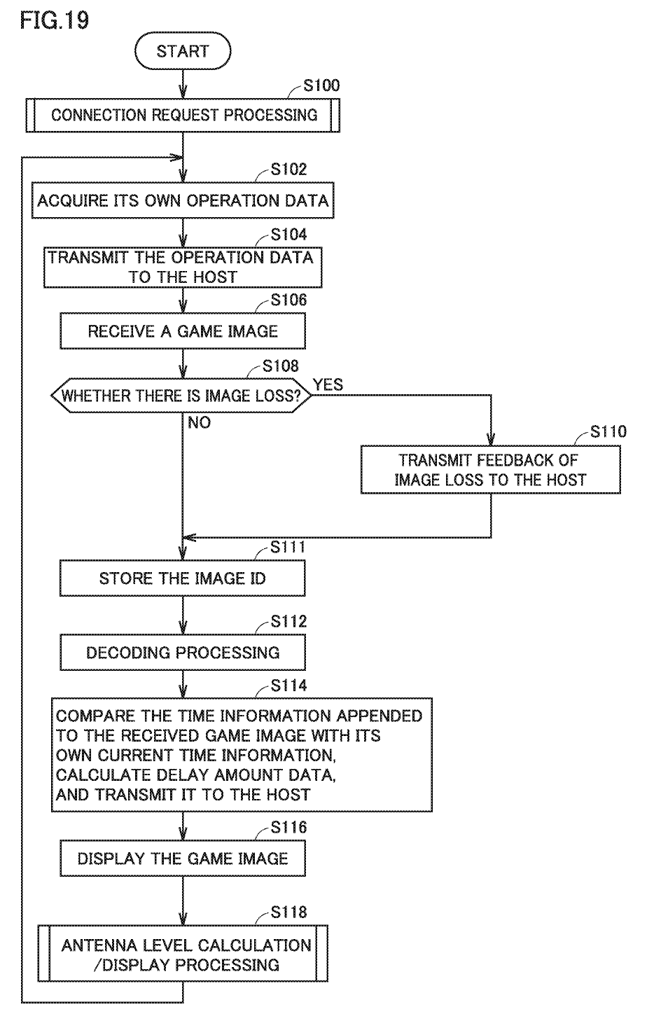

FIG. 19 is a flow diagram for explaining game processing of the game device (guest) according to the present embodiment. The processing procedure shown in FIG. 19 may be realized by the SoC 120 of each game device (guest) 100 executing the guest program 230 comprised in the system program 200 stored in the flash memory 106.

The SoC 120 of the game device (guest) executes connection request processing (step S100). Details of the connection request processing will be described later.

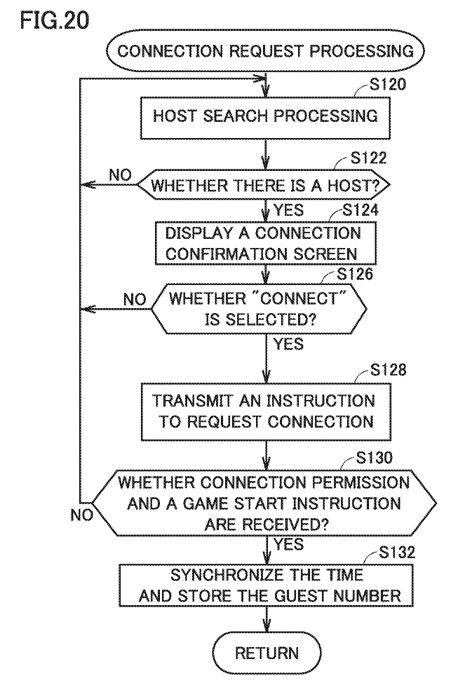

FIG. 20 is a subroutine flow diagram of connection request processing of the game device (guest) according to the present embodiment.

Referring to FIG. 20, there are various methods for the connection request processing, but a case of local wireless communication is described as an example. The SoC 120 of the game device (guest G(i)) 100 executes host search processing for searching for the game device (host) 100 that becomes the host (the host transmitting an advertisement for recruitment) using local wireless communication (step S120).

Next, the SoC 120 of the game device (guest G(i)) 100 determines whether there is a host (step S122). In step S122, when the SoC 120 of the game device (guest G(i)) 100 determines that there is no host (NO in step S122), the processing returns to step S120 and continues the host search processing.

On the other hand, in step S122, when the SoC 120 determines that there is a host (YES in step S122), the SoC 120 is configured to display a connection request confirmation screen for selecting whether a connection request is permitted on the display 104 (step S124).

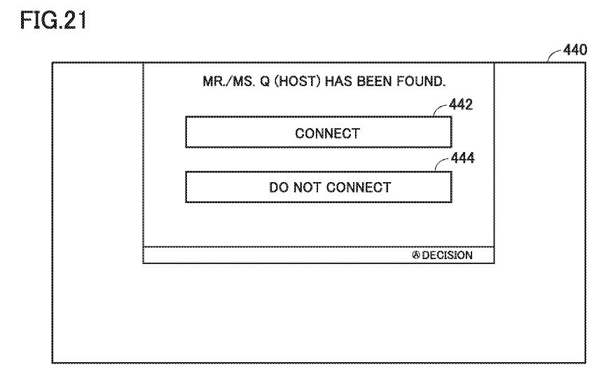

FIG. 21 is a diagram for explaining an example of a connection request confirmation screen according to the present embodiment. Referring to FIG. 21, the connection request confirmation screen 440 is provided with a "connect" button 442 for requesting connection and a "do not connect" button 444 for not requesting connection, for example, along with a comment "Mr./Ms. Q (host) has been found." For example, when a user who is the guest selects the "connect" button 442 on the connection request confirmation screen 440, an instruction to request connection is transmitted from the guest game device (guest) to the host game device (host) 100. On the other hand, when the user who is the guest selects the "do not connect" button 444 on the connection request confirmation screen 440, an instruction to request connection is not transmitted from the guest game device (guest) to the host game device (host) 100.

Referring to FIG. 20 again, the SoC 120 of the game device (guest G(i)) 100 determines whether "connect" is selected by the user who is the guest on the connection request confirmation screen 440 (step S126).

In step S126, when the SoC 120 of the game device (guest G(i)) 100 determines that "do not connect" is selected by the user who is the guest on the connection request confirmation screen 440 (NO in step S126), the processing returns to step S120.

On the other hand, in step S126, when the SoC 120 of the game device (guest G(i)) 100 determines that "connect" is selected by the user who is the guest on the connection request confirmation screen 440 (YES in step S126), the SoC 120 is configured to transmit an instruction to request connection from the guest game device (guest) to the host game device (host) 100 (step S128).

Next, the SoC 120 of the game device (guest G(i)) 100 determines whether connection permission and a game start instruction are received from the host game device (host) 100 (step S130).

In step S130, when the SoC 120 of the game device (guest G(i)) 100 determines that connection permission and a game start instruction are received from the host game device (host) 100 (YES in step S130), the SoC 120 receives and stores the guest number from the host along with processing for synchronizing the time (step S132). For example, the SoC 120 of the game device (guest G(i)) 100 receives the time data 306 and the guest number 304 from the game device (host) 100-1. The game device (guest G(i)) 100 receives the time data 306 and synchronizes the time. The SoC 120 of the game device (guest G(i)) 100 stores the received guest number 304 as the guest number 334 in the DRAM 108.

Then, the processing is terminated (return). The connection request processing in the case of local wireless communication has been described above, but for example, in the case of Internet communication, host search processing for accessing the matching room generated by the management server 300 and searching for the game device (host) 100 may be executed. Then, the connection request confirmation screen described in FIG. 21 may be displayed on the display 104 regarding the host found in the matching room to select whether a connection request is permitted. When the user who is the guest requests connection, an instruction to request connection may be transmitted from the guest game device (guest) 100 to the host game device (host) 100 via the management server 300, and the host information, the guest number, and the time data may be transmitted from the host game device (host) 100 to the guest game device (guest) 100 along with connection permission and a game start instruction.

Referring to FIG. 19 again, next, the SoC 120 of the game device (guest G(i)) 100 acquires its own operation data (step S102). The SoC 120 of the game device (guest G(i)) 100 acquires the operation data (guest) 338 stored in the DRAM 108.

Next, the SoC 120 of the game device (guest G(i)) 100 transmits the operation data (guest) 338 to the host (step S104).

Next, the SoC 120 of the game device (guest G(i)) 100 receives a game image (step S106). For example, the SoC 120 of the game device (guest G(i)) 100 receives the transmitted game image (guest G(i)) 314 and stores it as the game image 340.

Next, the SoC 120 of the game device (guest G(i)) 100 determines whether there is image loss (step S108). The SoC 120 of the game device (guest G(i)) 100 refers to the image ID 341 of the most recent image and compares it with the image ID associated with the game image received from the host to determine whether there is image loss. For example, when the image ID is a serial ID, if the serial IDs are arriving in sequence, it is determined that no image loss has occurred. On the other hand, if the image IDs are not in sequence and there is a gap, it is determined that an image loss corresponding to the missing image ID has occurred.

In step S108, when the SoC 120 of the game device (guest G(i)) 100 determines that there is image loss (YES in step S108), the SoC 120 transmits feedback of image loss to the host (step S110). For example, the SoC 120 of the game device (guest G(i)) 100 transmits feedback comprising information on the serial ID before and after the loss, or the number of the missing serial ID, to the game device (host) 100.

Next, the SoC 120 of the game device (guest G(i)) 100 stores the serial ID associated with the received game image as the serial ID 341 of the most recent image.

On the other hand, in step S108, when the SoC 120 of the game device (guest G(i)) 100 determines that there is no image loss (NO in step S108), the SoC 120 skips step S110 and proceeds to step S111.

Next, the SoC 120 of the game device (guest G(i)) 100 executes decoding processing (step S112). For example, the transmitted encoded game image (guest G(i)) 314 comprises information related to the encoding mode used for the encoding processing. The SoC 120 of the game device (guest G(i)) 100 executes decoding processing on the encoded image data based on the information related to the encoding mode and expands it in the frame buffer 110.

Next, the SoC 120 of the game device (guest G(i)) 100 compares the time information appended to the received game image with its own current time information, calculates delay amount data, and transmits it to the host (step S114). For example, the SoC 120 of the game device (guest G(i)) 100 compares the time information appended to the received game image with the time data 336, calculates delay amount data 343 related to the delay amount, and transmits the calculated delay amount data 343 to the game device (host) 100.

Next, the SoC 120 of the game device (guest G(i)) 100 displays the decoded game image (step S116). For example, the SoC 120 displays the game image expanded in the frame buffer 110 on the display 104.

Next, the SoC 120 of the game device (guest G(i)) 100 executes antenna level calculation/display processing (step S118). The antenna level calculation/display processing is realized by the SoC 120 executing the guest program 230. Details of the antenna level calculation/display processing will be described later. Then, the processing returns to step S102 again and continues the processing.

For example, the calculation of the antenna level may be performed based on both the communication status (image loss data and delay amount data) in communication of the game image and the encoding bit rate (target bit rate and observed bit rate), or may be performed based on one of them. The calculation of the antenna level may be performed based on the communication status (image loss data) and the target bit rate or the observed bit rate. The calculation of the antenna level may be performed based on a comparison result based on a comparison between the target bit rate and the observed bit rate. The determination of the communication status may determine both the delay amount data of the game image and the image loss data on the communication path, or may determine one of them. The determination of the communication status, when local wireless communication is selected, may be performed based on at least the image loss data on the communication path, and when Internet communication is selected, may be performed based on at least the delay amount data. The determination of the communication status, when local wireless communication is selected, may be performed based on the target bit rate and the image loss data on the communication path, and when Internet communication is selected, may be performed based on the target bit rate and the delay amount data.

The antenna level display processing may be a single icon that changes based on both the communication status in communication of the game image and the encoding bit rate.

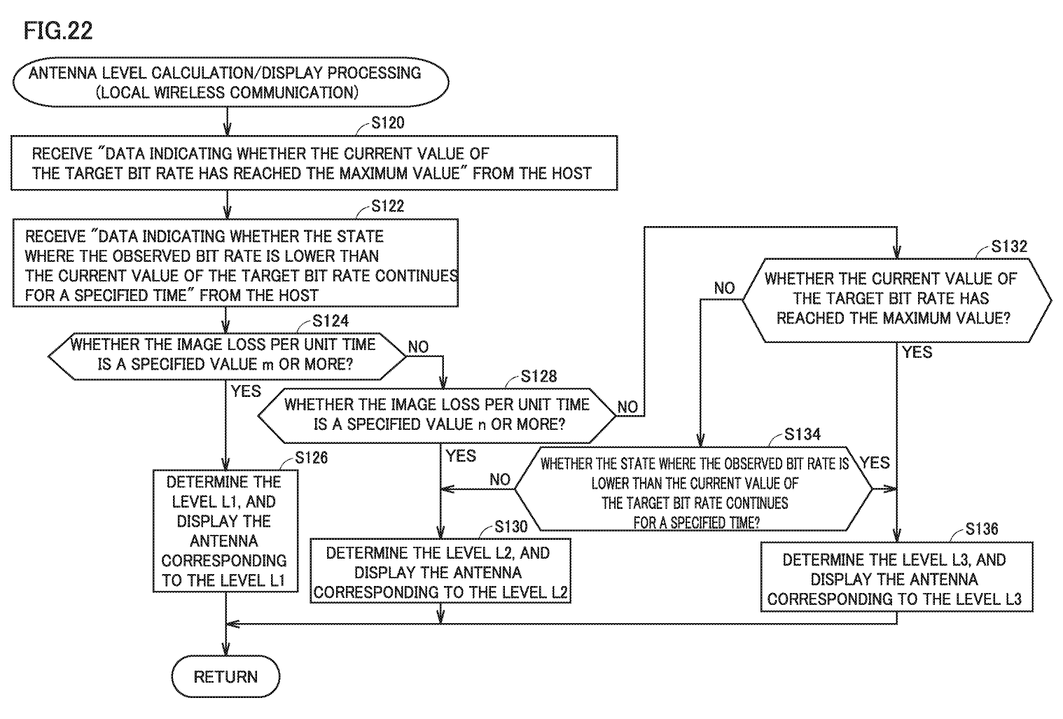

FIG. 22 is a subroutine flow diagram of antenna level calculation/display processing according to the present embodiment. Referring to FIG. 22, the case of local wireless communication is described here. The SoC 120 of the game device (guest G(i)) 100 receives "data indicating whether the current value of the target bit rate of the guest G(i) has reached the maximum value" from the host (step S120).

Next, the SoC 120 of the game device (guest G(i)) 100 receives "data indicating whether the state where the observed bit rate of the guest G(i) is lower than the current value of the target bit rate continues for a specified time" from the host (step S122).

Next, the SoC 120 of the game device (guest G(i)) 100 determines whether the image loss per unit time is a specified value m or more (step S124). For example, the SoC 120 of the game device (guest G(i)) 100 may refer to the image loss data 342, count the number of missing serial IDs associated with the game image most recently received from the host per unit time, and determine whether the image loss is the specified value m or more. Alternatively, the SoC 120 of the game device (guest G(i)) 100 may determine whether the image loss is the specified value m or more based on the number of times feedback is transmitted per unit time.

In step S124, when the SoC 120 of the game device (guest G(i)) 100 determines that the image loss per unit time is the specified value m or more (YES in step S124), the SoC 120 determines the level L1, stores it as the antenna level data 344, and displays the antenna corresponding to the level L1 (step S126). Then, the processing is terminated (return).

On the other hand, in step S124, when the SoC 120 of the game device (guest G(i)) 100 determines that the image loss per unit time is less than the specified value m (NO in step S124), the SoC 120 determines whether the image loss per unit time is a specified value n or more (step S128).

On the other hand, in step S128, when the SoC 120 of the game device (guest G(i)) 100 determines that the image loss per unit time is the specified value n or more (YES in step S128), the SoC 120 determines the level L2, stores it as the antenna level data 344, and displays the antenna corresponding to the level L2 (step S130). Then, the processing is terminated (return).

On the other hand, in step S128, when the SoC 120 of the game device (guest G(i)) 100 determines that the image loss per unit time is less than the specified value n (NO in step S128), the SoC 120 determines whether the current value of the target bit rate has reached the maximum value (step S132).

In step S132, when the SoC 120 of the game device (guest G(i)) 100 determines that the current value of the target bit rate has reached the maximum value (YES in step S132), the SoC 120 determines the level L3, stores it as the antenna level data 344, and displays the antenna corresponding to the level L3 (step S136). For example, the SoC 120 of the game device (guest G(i)) 100 may determine the level L3 when the flag received in step S120 is "1." Then, the processing is terminated (return).

On the other hand, in step S132, when the SoC 120 of the game device (guest G(i)) 100 determines that the current value of the target bit rate has not reached the maximum value (NO in step S132), the SoC 120 determines whether the state where the observed bit rate is lower than the current value of the target bit rate continues for a specified time (step S134). For example, when the flag received in step S120 is "1," the SoC 120 of the game device (guest G(i)) 100 determines whether the flag received in step S122 is "1."

In step S134, when the SoC 120 of the game device (guest G(i)) 100 determines that the state where the observed bit rate is lower than the current value of the target bit rate continues for a specified time (YES in step S134), the SoC 120 displays the antenna of the level L3 (step S136). Then, the processing is terminated (return). For example, the SoC 120 of the game device (guest G(i)) 100 may determine the level L3 when the flag received in step S122 is "1." In the case of a simple game image, the target bit rate may not reach the maximum value, so the level L3 is determined when the image quality is stable, that is, the state where the observed bit rate is lower than the current value of the target bit rate continues for a specified time.

On the other hand, in step S134, when the SoC 120 of the game device (guest G(i)) 100 determines that the state where the observed bit rate is lower than the current value of the target bit rate does not continue for a specified time (NO in step S134), the SoC 120 displays the antenna of the level L2 (step S130). Then, the processing is terminated (return). For example, the SoC 120 of the game device (guest G(i)) 100 may determine the level L2 when the flag received in step S122 is "0."

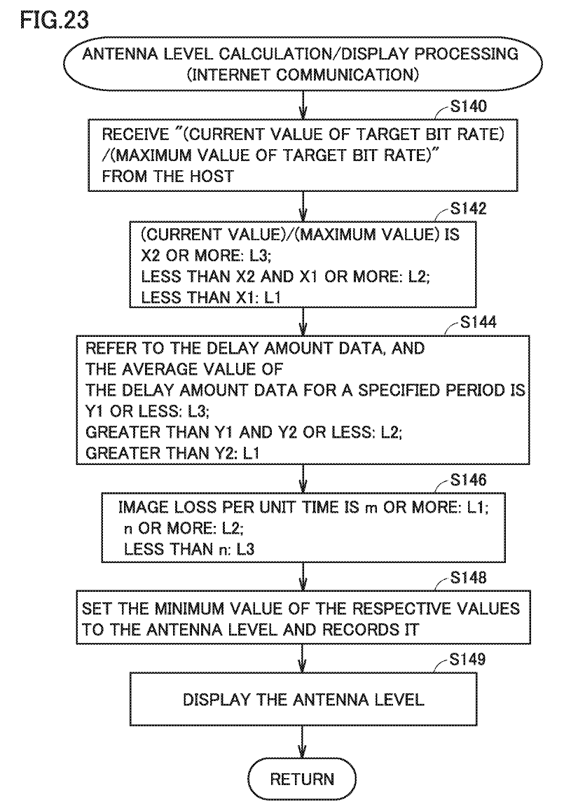

FIG. 23 is another subroutine flow diagram of antenna level calculation/display processing according to the present embodiment. Referring to FIG. 23, the case of Internet communication is described here. The SoC 120 (guest) receives "data indicating whether (current value of target bit rate of guest G)/(maximum value of target bit rate) has reached the specified value" from the host (step S140).

Next, the SoC 120 of the game device (guest G(i)) 100 determines whether (current value of target bit rate of guest G)/(maximum value of target bit rate) is a specified value X2 or more, and determines the level L3 if it is the specified value X2 or more. The SoC 120 of the game device (guest G(i)) 100 determines the level L2 if (current value of target bit rate of guest G)/(maximum value of target bit rate) is less than the specified value X2 and a specified value X1 or more. The SoC 120 of the game device (guest G(i)) 100 determines the level L1 if (current value of target bit rate of guest G)/(maximum value of target bit rate) is less than the specified value X1 (step S142).

Next, the SoC 120 of the game device (guest G(i)) 100 refers to the delay amount data, determines whether an average value of the delay amount data for a specified period is a specified value Y1 or less, and determines the level L3 if it is the specified value Y1 or less. The SoC 120 of the game device (guest G(i)) 100 determines the level L2 if the average value of the delay amount data for the specified period is greater than the specified value Y1 and a specified value Y2 or less. The SoC 120 of the game device (guest G(i)) 100 determines the level L1 if the average value of the delay amount data for the specified period is greater than the specified value Y2 (step S144).

Next, the SoC 120 of the game device (guest G(i)) 100 determines whether the image loss per unit time is a specified value m or more, determines the level L1 if the image loss is the specified value m or more, determines the level L2 if the image loss is a specified value n or more, and determines the level L3 if the image loss is less than the specified value n (step S146). As described above, for example, the SoC 120 of the game device (guest G(i)) 100 may refer to the image loss data 342, count the number of missing serial IDs associated with the game image most recently received from the host per unit time, and determine whether the image loss is the specified value m or n or more. Alternatively, the SoC 120 of the game device (guest G(i)) 100 may determine whether the image loss is the specified value m or n or more based on the number of times feedback is transmitted per unit time.

Next, the SoC 120 of the game device (guest G(i)) 100 sets the average value of the respective values to the antenna level and records it (step S148). Note that the minimum value of the respective values may be set to the antenna level. For example, the SoC 120 of the game device (guest G(i)) 100 stores the determined data as the antenna level data 344 in the DRAM 108.

Next, the SoC 120 of the game device (guest G(i)) 100 displays the antenna level based on the antenna level data 344 (step S149). Then, the processing is terminated (return).

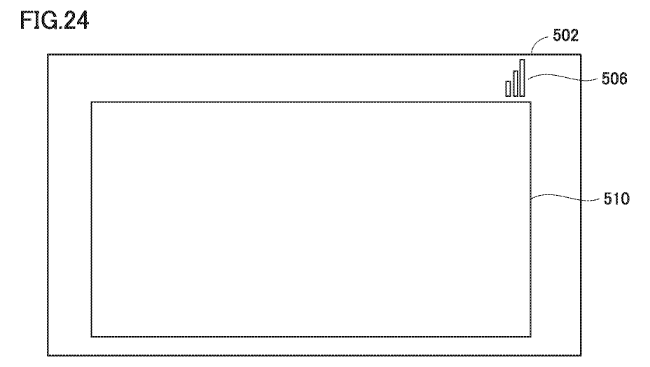

FIG. 24 is a diagram for explaining a screen of the display 104 of the game device according to the present embodiment. Referring to FIG. 24, a screen 502 of the display 104 is displayed. The screen 502 shows the case where a game image 510 is displayed, and an antenna 506 indicating display quality is displayed. The SoC 120 of the game device (host) 100 displays the antenna 506 based on the antenna level data 324. The SoC 120 of the game device (guest G(i)) 100 displays the antenna 506 based on the antenna level data 344. In the present embodiment, an icon with three antenna bars corresponding to the level L3 is displayed. For example, an icon with two antenna bars may be displayed in the case of the level L2, and an icon with one antenna bar may be displayed in the case of the level L1. Note that the information indicating display quality may be displayed in other forms, such as numerical values or characters, not limited to the number of antenna bars. This allows the host user to easily grasp the display quality of the transmitted image by checking the antenna 506 of the game device (host) 100. The antenna level data 324 is the antenna level data with the lowest level among the antenna level data 326 of the game device (guest G(i)) 100. Therefore, it is easy to take appropriate measures, such as improving the communication status as the host, according to the level of the display quality. In addition, the guest user can easily grasp the display quality of the received image by checking the antenna 506 of the game device (guest) 100. Therefore, it is easy to take appropriate measures, such as improving the communication status as the guest, according to the level of the display quality.

In a game using the game sharing function in which the host device generates a game image and transmits it to the guest device, conveying the current display quality of the game image at the guest device can be a problem, but in the present embodiment, since the display quality is displayed in real time with the game image by a single icon, the display quality of the game image during play can be known in real time.

### F. Modifications

Regarding the antenna level calculation/display processing according to the above embodiment, the case where the antenna level is determined and the determination result is displayed on each side of the game device (guest G(i)) 100 has been described. On the other hand, the antenna level of each game device (guest G(i)) 100 may be determined on the side of the game device (host) 100. For example, in local wireless communication, the SoC 120 of the game device (host) 100 may hold "data indicating whether the current value of the target bit rate of the guest G(i) has reached the maximum value" and "data indicating whether the state where the observed bit rate of the guest G(i) is lower than the current value of the target bit rate continues for a specified time" without transmitting them to the game device (guest G(i)) 100, and perform the determination by executing the processing described in FIG. 22 using the image loss data 320. The SoC 120 of the game device (host) 100 may transmit the determination result to the game device (guest G(i)) 100 and display the antenna 506 based on the received antenna level data 344 according to the determination result. This is applicable to Internet communication as well, not limited to the case of local wireless communication. In the case of Internet communication, the SoC 120 of the game device (host) 100 may hold the antenna level calculated according to the method described in FIG. 23 instead of the processing in step S12 of FIG. 7 as the antenna level data (host) 324 and display it on the display 104.

The target bit rate setting processing (FIG. 14) and the antenna level calculation/display processing (FIG. 22) for local wireless communication may be used in the case of Internet communication. Also, the target bit rate setting processing (FIG. 15) and the antenna level calculation/display processing (FIG. 23) for Internet communication may be used in the case of local wireless communication.

In the above embodiment, the game system that mainly executes game processing has been described, but the present invention is not limited to game processing. For example, it is similarly applicable to an information processing system that distributes a moving image. For example, a first information processing apparatus encodes and transmits a moving image, a second information processing apparatus receives and displays the moving image transmitted from the first information processing apparatus, and display quality of the moving image at the second information processing apparatus is determined based on a communication status in communication of the moving image and an encoding bit rate, and a single icon indicating the display quality may be displayed on a display of the second information processing apparatus along with the moving image.

The embodiments disclosed this time should be considered in all respects as illustrative and not restrictive. The scope of the present invention is indicated by the scope of the claims, not by the foregoing description, and is intended to include all modifications within the meaning and range equivalent to the scope of the claims.

What is claimed is:

1. A game system comprising a first game device and a second game device,
wherein the first game device is configured to perform operations comprising:
receiving operation data of the second game device;
executing a game program using its own operation data and the received operation data to generate a game image;
encoding the generated game image in a method in which a bit rate changes; and
transmitting the encoded game image to the second game device, and
the game system is configured to perform operations comprising:
determining display quality of the game image displayed at the second game device based on at least one of a communication status in communication of the game image and the encoding bit rate; and
displaying, with the game image, an icon indicating the display quality on a display of the second game device.

2. The game system according to claim 1, wherein
the determination is performed based on at least the communication status in communication of the game image and the encoding bit rate; and
the icon is a single icon that changes based on at least the communication status in communication of the game image and the encoding bit rate.

3. The game system according to claim 2, wherein:
the encoding is performed in a method in which a set bit rate changes according to the communication status; and
the determination is performed based on at least the communication status and the set bit rate.

4. The game system according to claim 2, wherein
the encoding is performed in a method in which a resulting bit rate changes according to an information amount of the game image; and
the determination is performed based on at least the communication status and the resulting bit rate.

5. The game system according to claim 2, wherein
the operations further comprise determining the communication status according to at least communication delay and data loss on a communication path of the game image.

6. The game system according to claim 1, wherein:
the operations further comprise receiving a selection input between local wireless communication and Internet communication as a communication method for transmitting the game image; and
the determination,
when the local wireless communication is selected in the selection input, is performed based on at least data loss on a communication path of the game image, and
when the Internet communication is selected, is performed based on at least communication delay of the game image.

7. The game system according to claim 6, wherein
the encoding is performed in a method in which a set bit rate changes according to the communication status; and
the determination
is performed based on at least the set bit rate and data loss on a communication path of the game image when the local wireless communication is selected in the selection input, and
is performed based on the set bit rate and communication delay of the game image when the Internet communication is selected in the selection input.

8. The game system according to claim 1, comprising a plurality of second game devices, wherein
the determination is performed based on at least the communication status and the encoding bit rate for each second game device; and
the icon is displayed for each second game device.

9. The game system according to claim 8, wherein
the encoding is performed in a method in which a set bit rate changes according to the communication status;
a maximum value of the set bit rate is determined according to the number of the plurality of second game devices; and
the determination is performed by comparing a current set bit rate with the maximum value of the set bit rate for each second game device.

10. One or more non-transitory computer-readable storage media storing instructions that cause one or more processors or processing circuits of a second game device of a game system comprising a first game device and the second game device to perform operations comprising:
receiving an encoded game image generated and encoded by the first game device and encoding quality data of the game image, from the first game device;
determining display quality of the game image displayed at the second game device based on at least a communication status in communication of the game image and the received encoding quality data; and
displaying, with the game image, an icon indicating the display quality on a display of the second game device.

11. The one or more non-transitory computer-readable storage media according to claim 10, wherein
the encoding is performed in a method in which a set bit rate changes according to the communication status; and
the encoding quality data includes data indicating the set bit rate.

12. The one or more non-transitory computer-readable storage media according to claim 11, wherein
the encoding is further performed in a method in which a resulting bit rate changes according to an information amount of the game image; and
the encoding quality data includes data indicating the resulting bit rate.

13. The one or more non-transitory computer-readable storage media according to claim 12, wherein
in the encoding, the value of the set bit rate is changed based on a comparison between the set bit rate and the resulting bit rate; and
the determination is performed based on the comparison result.

14. The one or more non-transitory computer-readable storage media according to claim 10, wherein
the operations further comprise determining the communication status by determining both communication delay and data loss on a communication path of the game image.

15. The one or more non-transitory computer-readable storage media according to claim 10, wherein
the determination,
when local wireless communication is selected for transmitting a game image, is performed based on at least data loss on a communication path of the game image, and
when the Internet communication is selected, is performed based on at least communication delay of the game image.

16. The one or more non-transitory computer-readable storage media according to claim 15, wherein
the encoding is performed in a method in which a set bit rate changes according to the communication status; and
the determination
is performed based on the set bit rate and data loss on a communication path of the game image when the local wireless communication is selected in the selection input, and
is performed based on the set bit rate and communication delay of the game image when the selection input of the Internet communication is received.

17. The one or more non-transitory computer-readable storage media according to claim 10, wherein
the encoding is performed in a method in which a set bit rate changes according to the communication status;
a maximum value of the set bit rate is determined according to the number of the second game devices; and
the determination is performed by comparing a current set bit rate with the maximum value of the set bit rate.

18. A computer-implemented method for controlling a game system comprising a first game device and a second game device, comprising:
the first game device performing:
receiving operation data of the second game device;
executing a game program using its own operation data and the received operation data by the first game device;
generating a game image;
encoding the generated game image in a method in which a bit rate changes; and
transmitting the encoded game image to the second game device; and the game system performing:
determining display quality of the game image displayed at the second game device based on at least a communication status in communication of the game image and an encoding bit rate; and
displaying, with the game image, an icon indicating the display quality on a display of the second game device.

19. The computer-implemented method according to claim 18, wherein
the encoding is performed in a method in which a set bit rate changes according to the communication status; and
the determining is performed based on at least the communication status and the set bit rate.

20. The computer-implemented method according to claim 19, wherein
the encoding is performed in a method in which a resulting bit rate changes according to an information amount of the game image; and
the determining is performed based on at least the communication status and the resulting bit rate.

21. The computer-implemented method according to claim 20, wherein
in the encoding, the value of the set bit rate is changed based on a comparison between the set bit rate and the resulting bit rate; and
the determining is performed based on at least the comparison result.

22. The computer-implemented method according to claim 18, wherein
the determining is performed based on the encoding bit rate for each second game device.
